(19) United States
(12) Patent Application Publication
(10) Pub. No.: US 2023/0167224 A1
(43) Pub. Date: Jun. 1, 2023

(54) TRIGLYCERIDE OILS, POLYOLS, AND USES THEREOF

(71) Applicant: Checkerspot, Inc., Alameda, CA (US)

(72) Inventors: Scott FRANKLIN, Woodside, CA (US); Zoran PETROVIC, Pittsburg, KS (US); Jian HONG, Overland Park, KS (US); Milica LOVRIC VUKOVIC, Cacak (RS); Jasna DJONLAGIC, Pittsburg, KS (US)

(21) Appl. No.: 18/072,224

(22) Filed: Nov. 30, 2022

Related U.S. Application Data
(63) Continuation of application No. PCT/US2021/034538, filed on May 27, 2021.
(60) Provisional application No. 63/032,900, filed on Jun. 1, 2020.

(51) Int. Cl. C08G 18/02; C08J 7/04

(52) U.S. Cl. CPC C08G 18/02; C08J 7/04; C08J 2375/04

(57) ABSTRACT

Provided herein are surface treating compositions for imparting beneficial surface properties to substrates. The compositions can be prepared by reacting a bio-based polyol with an isocyanate group-containing compound and an ionogenic molecule. The compositions can be used to treat a variety of substrates to provide enhanced properties to a surface of the substrate. Also provided are methods for the chemical modification of triglycerides and fatty acids and use thereof in creating beneficial surface treating compositions.

### CROSS REFERENCE

This application is a continuation of International Application No. PCT/US2021/034538, filed on May 27, 2021, which claims the benefit of U.S. Provisional Application No. 63/032,900, filed on Jun. 1, 2020, which is incorporated herein by reference in its entirety.

### BACKGROUND OF THE INVENTION

Various compositions can be useful for providing beneficial surface properties to substrates. Surface treating agents prepared with fluorinated compounds, for example, are prevalent in the market. However, due to environmental and human health concerns, there is an increasing interest to reduce the use of or replace fluorochemicals with fluorine-free surface treating products. Ecolabels such as “Blue Angel,” which is awarded by RAL gGmbH, St. Augustin, Germany and others are continuously reinforcing this trend.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In some aspects, the present disclosure provides a method for producing a polyurethane dispersion, the method comprising: a) epoxidizing and ring opening an algal oil, thereby generating an epoxidized and ring opened algal oil polyol; b) reacting the epoxidized and ring opened algal oil polyol with an isocyanate and an ionogenic molecule, thereby generating an isocyanate-terminated pre-polymer; c) neutralizing the isocyanate-terminated pre-polymer with an acid or a base, thereby generating a neutralized isocyanate-terminated pre-polymer; and d) dispersing the neutralized isocyanate-terminated pre-polymer in water, thereby generating the polyurethane dispersion, wherein the algal oil comprises at least 60% of one or more monounsaturated fatty acids.

In some aspects, the present disclosure provides a method for producing a polyurethane dispersion, the method comprising: a) hydroformylating and hydrogenating an algal oil, thereby generating a hydroformylated algal oil polyol; b) reacting the hydroformylated algal oil polyol with an isocyanate and an ionogenic molecule, thereby generating an isocyanate-terminated pre-polymer; c) neutralizing the isocyanate-terminated pre-polymer with an acid or a base, thereby generating a neutralized isocyanate-terminated pre-polymer; and d) dispersing the neutralized isocyanate-terminated pre-polymer in water, thereby generating the polyurethane dispersion, wherein the algal oil comprises at least 60% of one or more unsaturated fatty acids.

In some aspects, the present disclosure provides a method for producing a cationic polyurethane dispersion, the method comprising: a) epoxidizing an algal oil, thereby generating an epoxidized algal oil; b) ring opening the epoxidized algal oil in the presence of ethanol, thereby generating an algal oil polyol; c) reacting the polyol with an isocyanate and N-methyldiethanolamine (MDEA), thereby generating an isocyanate-terminated pre-polymer; d) neutralizing the isocyanate-terminated pre-polymer with acetic acid, thereby generating a neutralized isocyanate-terminated pre-polymer; and e) dispersing the neutralized isocyanate-terminated pre-polymer in water, thereby generating the polyurethane dispersion, wherein the algal oil comprises at least 60% of oleic acid, wherein the molar ratio of the algal oil polyol, the MDEA, and the isocyanate is about 1 to about 1 to about 2, respectively.

In some aspects, the present disclosure provides a method for producing an anionic polyurethane dispersion, the method comprising: a) epoxidizing an algal oil, thereby generating an epoxidized algal oil; b) ring opening the epoxidized algal oil in the presence of ethanol, thereby generating an algal oil polyol; c) reacting the algal oil polyol with an isocyanate and dimethylolpropionic acid (DMPA), thereby generating an isocyanate-terminated pre-polymer; d) neutralizing the isocyanate-terminated pre-polymer with triethylamine (TEA), thereby generating a neutralized isocyanate-terminated pre-polymer; and e) dispersing the neutralized isocyanate-terminated pre-polymer in water, thereby generating the anionic polyurethane dispersion, wherein the algal oil comprises at least 60% of oleic acid.

In some aspects, the present disclosure provides a method for producing a cationic polyurethane dispersion, the method comprising: a) epoxidizing an algal oil, thereby generating an epoxidized algal oil; b) ring opening the epoxidized algal oil in the presence of ethanol, thereby generating an algal oil polyol; c) reacting the polyol with an isocyanate and N-methyldiethanolamine (MDEA), thereby generating an isocyanate-terminated pre-polymer; d) neutralizing the isocyanate-terminated pre-polymer with acetic acid, thereby generating a neutralized isocyanate-terminated pre-polymer; and e) dispersing the neutralized isocyanate-terminated pre-polymer in water, thereby generating the cationic polyurethane dispersion, wherein the algal oil comprises at least 60% of oleic acid, wherein the molar ratio of the polyester diol, the isocyanate, the MDEA, and the EDA is about 1 to about 3.3 to about 2 to about 0.3, respectively.

In some aspects, the present disclosure provides a method for producing a cationic polyurethane dispersion, the method comprising: a) epoxidizing an algal oil, thereby generating an epoxidized algal oil; b) ring opening the epoxidized algal oil in the presence of ethanol, thereby generating an algal oil polyol; c) reacting the polyol with an isocyanate and N-methyldiethanolamine (MDEA), thereby generating an isocyanate-terminated pre-polymer; d) neutralizing the isocyanate-terminated pre-polymer with acetic acid, thereby generating a neutralized isocyanate-terminated pre-polymer; and e) dispersing the neutralized isocyanate-terminated pre-polymer in water, thereby generating the cationic polyurethane dispersion, wherein the algal oil comprises at least 60% of oleic acid, wherein the molar ratio of the polyester diol, the isocyanate, the MDEA, and the EDA is about 0.8 to about 3.5 to about 2.2 to about 0.3, respectively.

In some aspects, the present disclosure provides a method for producing a polyurethane dispersion, the method comprising: a) epoxidizing and ring opening an algal oil, thereby generating an epoxidized and ring opened polyester polyol; b) methylating the epoxidized and ring opened polyester polyol, thereby generating an epoxidized and ring opened methyl ester; optionally, c) polyesterifying the epoxidized and ring opened methyl ester in the presence of an initiator, thereby generating a polyester diol; d) reacting the polyester polyol or the polyester diol with an excess of isocyanate and an ionogenic molecule, thereby generating an isocyanate-terminated pre-polymer; e) neutralizing the isocyanate-terminated pre-polymer with an acid or a base, thereby generating a neutralized isocyanate-terminated pre-polymer; and optionally, f) reacting the neutralized isocyanate-terminated pre-polymer with a chain extender in the presence of water, thereby generating the polyurethane dispersion, wherein the algal oil comprises at least 60% of one or more monounsaturated fatty acids.

In some aspects, the present disclosure provides a method for producing a polyurethane dispersion, the method comprising: a) hydroformylating and hydrogenating an algal oil, thereby generating a hydroformylated polyester polyol; b) methylating the hydroformylated polyester polyol, thereby generating a hydroformylated methyl ester; optionally, c) polyesterifying the hydroformylated methyl ester in the presence of an initiator, thereby generating a polyester diol; d) reacting the polyester polyol or the polyester diol with an excess of isocyanate and an ionogenic molecule, thereby generating an isocyanate-terminated pre-polymer; e) neutralizing the isocyanate-terminated pre-polymer with an acid or a base, thereby generating a neutralized isocyanate-terminated pre-polymer; and optionally, f) reacting the neutralized isocyanate-terminated pre-polymer with a chain extender in the presence of water, thereby generating the polyurethane dispersion, wherein the algal oil comprises at least 60% of one or more unsaturated fatty acids.

In some embodiments of the aspects above, the one or more monounsaturated fatty acids is a C18:1 fatty acid. In some embodiments of the aspects above, the one or more monounsaturated fatty acids is oleic acid. In some embodiments of the aspects above, the algal oil comprises at least 80% of one or more monounsaturated fatty acids. In some embodiments of the aspects above, the algal oil comprises at least 90% of one or more monounsaturated fatty acids.

In some embodiments of the aspects above, the algal oil comprises at least 60% of oleic acid. In some embodiments of the aspects above, the algal oil comprises at least 80% of oleic acid. In some embodiments of the aspects above, the algal oil comprises at least 90% of oleic acid.

In some embodiments of the aspects above, the algal oil has an iodine value of at least 80 g I₂/100 g. In some embodiments of the aspects above, the algal oil has an iodine value of 88 g I₂/100 g.

In some embodiments of the aspects above, the isocyanate is isophorone diisocyanate (IPDI). In some embodiments of the aspects above, the ionogenic molecule is dimethylolpropionic acid (DMPA). In some embodiments of the aspects above, the ionogenic molecule is N-methyldiethanolamine (MDEA). In some embodiments of the aspects above, the acid or the base is equimolar to the ionogenic molecule.

In some embodiments of the aspects above, the neutralizing of the isocyanate-terminated pre-polymer is with acetic acid. In some embodiments of the aspects above, the neutralizing of the isocyanate-terminated pre-polymer is with triethylamine (TEA).

In some embodiments of the aspects above, the method further comprises reacting the neutralized isocyanate-terminated pre-polymer with a chain extender prior to dispersing. In some embodiments of the aspects above, the chain extender is ethylene diamine (EDA).

In some embodiments of the aspects above, the dispersing of the neutralized isocyanate-terminated pre-polymer in water is by mixing at 1,000 rpm for at least 2 hours. In some embodiments of the aspects above, the dispersing of the neutralized isocyanate-terminated pre-polymer in water is by mixing at 10,000 rpm for at least 5 minutes.

In some embodiments of the aspects above, the method further comprises solubilizing the isocyanate-terminated pre-polymer in methyl ethyl ketone prior to neutralizing.

In some embodiments of the aspects above, the polyurethane dispersion comprises less than 1% of an organic solvent. In some embodiments of the aspects above, the polyurethane dispersion comprises less than 0.5% of an organic solvent.

In some embodiments of the aspects above, the polyurethane dispersion is a cationic polyurethane dispersion. In some embodiments of the aspects above, the polyurethane dispersion is an anionic polyurethane dispersion.

In some embodiments of the aspects above, the polyurethane dispersion has a bio-based content of at least 50% as assessed by ASTM 6866.

In some embodiments of the aspects above, the polyurethane dispersion has a hard segment content of 30% to 45% as determined gravimetrically. In some embodiments of the aspects above, the polyurethane dispersion has a hard segment content of 40% to 45% as determined gravimetrically.

In some embodiments of the aspects above, the polyurethane dispersion has a solids content of 20% to 30% as determined gravimetrically.

In some embodiments of the aspects above, the polyurethane dispersion has a maximum particle size of less than about 100 nm as determined by dynamic light scattering.

In some embodiments of the aspects above, the polyurethane dispersion has a polydispersity index of less than about 0.15 as determined by dynamic light scattering.

In some embodiments of the aspects above, the polyurethane dispersion has a viscosity of less than about 10 mPa·s at ambient temperature.

In some embodiments of the aspects above, the polyurethane dispersion has a glass transition temperature of 10° C. to about 20° C. as determined by differential scanning calorimetry.

In some embodiments of the aspects above, the method further comprises preparing a film with the polyurethane dispersion, wherein the film is water repellent. In some embodiments of the aspects above, the method further comprises preparing a film with the polyurethane dispersion, wherein the film is oil repellent. In some embodiments of the aspects above, the method further comprises preparing a film with the polyurethane dispersion, wherein the film is stain resistant. In some embodiments of the aspects above, the method further comprises preparing a film with the polyurethane dispersion, wherein the film has a water contact angle of greater than 70 degrees. In some embodiments of the aspects above, the method further comprises preparing a film with the polyurethane dispersion, wherein the film has a water contact angle of greater than 90 degrees. In some embodiments of the aspects above, the method further comprises preparing a film with the polyurethane dispersion, wherein the film has a water absorption of less than 10% as determined gravimetrically. In some embodiments of the aspects above, the method further comprises preparing a film with the polyurethane dispersion, wherein the film has a water absorption of less than 5% as determined gravimetrically. In some embodiments of the aspects above, the method further comprises preparing a film with the polyurethane dispersion, wherein the film has a tensile strength of about 10 MPa to about 20 MPa. In some embodiments of the aspects above, the method further comprises preparing a film with the polyurethane dispersion, wherein the film has an elongation at break of about 200% to about 300%.

In some aspects, the present disclosure provides a polyurethane dispersion comprising a natural oil polyol, an isocyanate and optionally, an aromatic carboxylic acid, wherein the polyurethane dispersion has water repellent properties.

In some embodiments, the natural oil polyol is derived from a plant oil.

In some embodiments, the natural oil polyol is derived from a microbial oil.

In some embodiments, the natural oil polyol is derived from an algal oil.

In some embodiments, the isocyanate is a diisocyanate.

In some embodiments, the optional aromatic carboxylic acid is bio-based.

In some embodiments, the optional aromatic carboxylic acid is derived from a plant.

In some embodiments, the optional aromatic carboxylic acid is derived from a microbe.

In some embodiments, the optional aromatic carboxylic acid is derived from an animal.

In some aspects, the present disclosure provides a method of preparing a polyurethane dispersion having water repellent properties, the method comprising: polymerizing a natural oil polyol with an isocyanate and optionally an aromatic carboxylic acid, thereby generating the polyurethane dispersion having water repellent properties.

In some embodiments, the method further comprises obtaining a natural oil polyol, an isocyanate, and optionally an aromatic carboxylic acid.

In some embodiments, the method further comprises subjecting a microbial oil to epoxidation and ring opening.

In some embodiments, the method further comprises diluting the polyurethane dispersion with water.

In some embodiments, the method further comprises applying the polyurethane dispersion to a fibrous substrate, generating a polyurethane coated material.

In some embodiments, the method further comprises applying of the polyurethane dispersion to a fibrous substrate by exhaustion, foam, flex-nip, nip, pad, kiss-roll, beck, skein, winch, liquid injection, overflow flood, roil, brush, roller, spray, dipping, or immersion.

In some embodiments, the method further comprises drying the polyurethane dispersion after applying it to a fibrous substrate.

In some embodiments, the method further comprises heating the polyurethane coated material after applying the polyurethane dispersion to a fibrous substrate.

In some aspects, the present disclosure provides a polyurethane dispersion comprising a methyl ester of a fatty alcohol derived from a natural oil, an isocyanate, and optionally an aromatic carboxylic acid, wherein the polyurethane dispersion has water repellent properties.

In some embodiments, the fatty alcohol is derived from a plant oil.

In some embodiments, the fatty alcohol is derived from a microbial oil.

In some embodiments, the fatty alcohol is derived from an algal oil.

In some embodiments, the optional aromatic carboxylic acid is methyl cinnamate.

In some embodiments, the optional aromatic carboxylic acid is methyl ferulate.

In some embodiments, the optional aromatic carboxylic acid is cinnamic acid.

In some embodiments, the polyurethane dispersion is hydrophobic.

In some embodiments, the polyurethane dispersion is superhydrophobic.

In some embodiments, the polyurethane dispersion is oil repellent.

In some embodiments, the polyurethane dispersion is stain-resistant.

In some embodiments, the polyurethane dispersion composition is applied to a fibrous substrate.

In some embodiments, the fibrous substrate is a textile.

In some aspects, the present disclosure provides a method for preparing a polyurethane dispersion having water repellent properties the method further comprising polymerizing a methyl ester of a fatty alcohol derived from a natural oil with an isocyanate and an optional aromatic carboxylic acid, thereby generating a polyurethane dispersion having water repellent properties.

In some embodiments, the method further comprises obtaining a methyl ester a fatty alcohol, an isocyanate, and an aromatic carboxylic acid.

In some embodiments, the method further comprises epoxidation and ring opening of a microbial oil to generate a natural oil polyol.

In some embodiments, the method further comprises applying the polyurethane dispersion to a fibrous substrate to a polyurethane coated material.

In some embodiments, the method further comprises applying the polyurethane dispersion to a fibrous substrate by exhaustion, foam, flex-nip, nip, pad, kiss-roll, beck, skein, winch, liquid injection, overflow flood, roil, brush, roller, spray, dipping, or immersion.

In some embodiments, the method further comprises drying the polyurethane dispersion after applying the polyurethane dispersion to a fibrous substrate.

In some embodiments, the method further comprises heating the polyurethane coated material after applying the polyurethane dispersion to a fibrous substrate.

In some embodiments, the methyl ester of a fatty alcohol is derived from a plant oil.

In some embodiments, the methyl ester of a fatty alcohol is derived from a microbial oil.

In some embodiments, the methyl ester of a fatty alcohol is derived from an algal oil.

In some embodiments, the polyurethane dispersion is stain-resistant.

In some aspects, the present disclosure provides a polyurethane dispersion comprising a methyl ester of a fatty alcohol and an isocyanate wherein then polyurethane dispersion has water repellent properties.

In some embodiments, the fatty alcohol is derived from a natural oil.

In some embodiments, the fatty alcohol is derived from a plant oil.

In some embodiments, the fatty alcohol is derived from a microbial oil.

In some embodiments, the fatty alcohol is derived from an algal oil.

In some aspects, the present disclosure provides a method for preparing a polyurethane dispersion having water repellent properties, the method comprising polymerizing a methyl ester of a fatty alcohol derived from a natural oil with an isocyanate, thereby generating polyurethane dispersion having water repellent properties.

In some embodiments, the method further comprises obtaining a methyl ester of a fatty alcohol from a natural oil and the isocyanate.

In some embodiments, the method further comprises subjecting a microbial oil to epoxidation and methanolysis, generating a methyl ester of the fatty alcohol from a natural oil.

In some aspects, the present disclosure provides a polyurethane dispersion comprising a natural oil polyol, a methyl ester of a fatty alcohol derived from a natural oil, an isocyanate, and optionally an aromatic carboxylic acid, wherein the polyurethane dispersion has water repellent properties.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a reaction scheme to create polyols from triglyceride oil via epoxidation and ring opening of fatty acid methyl esters (FAMEs).

FIG. 2 illustrates a reaction scheme to create polyols from triglyceride oil via epoxidation and ring opening, followed by generation of hydroxylated FAMEs.

FIG. 3 illustrates a reaction scheme to generate higher molecular weight polyols from polyols of FAMEs.

FIG. 4 illustrates a reaction to generate higher molecular weight polyols from polyols of FAMEs and diols.

FIG. 5 illustrates an overlay of gel permeation chromatography spectra of two polyester diols.

FIG. 6 illustrates the FT-IR spectra of two polyester diols.

FIG. 7 illustrates a reaction scheme to produce a cationic polyurethane dispersion based on an algal oil polyol.

FIG. 8 illustrates the FT-IR spectrum of a film prepared from a cationic polyurethane dispersion.

FIG. 9 illustrates the particle size distribution of the five polyurethane dispersion formulations.

FIG. 10 illustrates the particle size distribution of the two polyurethane dispersion formulations.

### DETAILED DESCRIPTION

The present invention provides compositions and methods for making compositions that impart improved surface properties to substrates. Improved surface properties can include repellency to moisture, repellency to oil, repellency to soil, stain resistance, softness, glide, wear resistance, abrasion resistance, heat resistance, and solvent resistance. These properties can be particularly useful for substrates, such as fibers, yarns, fabrics, textiles, leather, carpets, paper, wood, and other substrates.

Polymer materials containing a urethane structure can be used to impart beneficial surface properties to surface treating agents. Polyurethanes (PUs) are versatile polymeric materials with regard to both processing methods and mechanical properties. PUs have a principal chain structure composed of rigid hard and flexible soft segments. Due to the specific micro-phase structure formed between the hard and soft segments, along with a proper selection of reactants, PUs can exhibit properties spanning high performance elastomers to tough and rigid plastics. The wide range of achievable properties make PUs attractive for use in a variety of applications and end uses, including, but not limited to, surface treatments, coatings, binders, adhesives, sealants, and paints.

Similar to widely used polymers like polyethylene, polypropylene, and polystyrene, PUs are generally produced from fossil fuel-based feedstocks. As the increased utilization of fossil fuels poses an imminent threat to the climate, there is an urgent need to replace incumbent, petroleum-derived chemicals with more sustainable, renewable materials. Moreover, the uncertainty in terms of price and availability of petroleum, together with political and institutional tendencies toward the sustainable practices, make renewable sources of PUs desirable.

Conventional PU products can contain a significant amount of organic solvents and sometimes even free isocyanate monomers. With increasingly restrictive environmental regulations regarding volatile organic chemicals (VOCs), aqueous (or waterborne) polyurethane dispersions (PUDs) can be a promising alternative to conventional PUs.

Natural oils, such as vegetable oils, can be used as renewable raw materials in the chemical and polymer industries, due to their hydrophobicity, biodegradability, low toxicity, avoidance of volatile organic chemicals, and wide availability. Natural oil polyols (NOPs) can be used for PU production. However, limitations of vegetable oil-derived polyols can narrow their applicability in waterborne PUDs. For example, the inherently high triglyceride heterogeneity of vegetable oils can lead to structural and reactive heterogeneity of derivatives thereof, including polyol derivatives. Another compounding limitation is that vegetable oils can create a high degree of polyol hydroxyl group (—OH) functionality. High hydroxyl functionality of NOPs can lead to gelation, higher crosslinking, and consequent difficulties in dispersing highly crosslinked PU prepolymers in water.

Methods described herein include the use of bio-based, renewable raw materials to generate PUD compositions without compromising the beneficial properties of conventional PUDs.

As used herein, the term “triglyceride”, “triacylglycerol”, or “TAG” generally refers to an oil composed of three saturated and/or unsaturated fatty acids held together by a glycerol backbone.

As used herein, the term “bio-based” generally refers to materials sourced from biological products or renewable agricultural material, including plant, animal, and marine materials, forestry materials, or an intermediate feedstock. In some embodiments, a composition described herein is at least 10% bio-based. In some embodiments, a composition described herein is 10% to 100% bio-based, 35% to 100% bio-based, 50% to 100% bio-based, 75% to 100% bio-based, or 100% bio-based.

As used herein, the term “natural oil,” “natural triglyceride oil,” or “naturally occurring oil” generally refers to an oil derived from a plant, animal, fungi, algae, or bacterium that has not undergone additional chemical or enzymatic manipulation. In some embodiments, the term can exclude refining processes, for example, degumming, refining, bleaching, and deodorization.

As used herein, the term “polyol”, “biopolyol”, “natural oil polyol”, or “NOP” generally refers to a polyol produced in situ by a plant, animal, fungi, algae, or bacterium, or through chemical modification of a triglyceride oil or derivatives thereof obtained from a plant, animal, fungi, algae, or bacterium.

As used herein, the term “microbial oil” refers to an oil extracted from a microbe, e.g., an oleaginous, single-celled, eukaryotic or prokaryotic microorganism, including, but not limited to, yeast, microalgae, and bacteria.

As used herein, the term “iodine value” is an indicator of the number of carbon-carbon double bonds in the fatty acids of an oil composition. Iodine value is determined by the mass of iodine in grams that is consumed by 100 grams of an oil composition.

As used herein, the term “oleic content” or “olein content” refers the percentage amount of oleic acid in the fatty acid profile of a substance (e.g., a polyol). As used herein, the term “C18:1 content” refers the percentage amount of a C18:1 fatty acid (e.g., oleic acid) in the fatty acid profile of a substance (e.g., a polyol).

As used herein, the term “hydroxyl number”, “hydroxyl value”, or “OH #” of the resulting polyol refers to the number of milligrams of potassium hydroxide (mg KOH/g) required to neutralize the acetic acid taken up on acetylation of one gram of a substance (e.g., a polyol) that contains free hydroxyl groups. The hydroxyl number is a measure of the content of free hydroxyl groups in the substance. The hydroxyl number can be determined by ASTM E1899.

As used herein, the term “about” refers to ±10% from the value provided.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are described herein.

### Polyurethanes

Polyurethanes are polymers that have a molecular backbone containing carbamate/urethane groups (—NHCO₂). Segmented polymers are composed of alternating sequences of soft segments and hard segments. Polyurethanes are produced by reacting polyols with isocyanates in the presence of catalyst. In some cases, polyurethanes are produced by the addition of a linker or chain extender and other additives.

### Isocyanates

Diisocyanates can be used in producing polyurethane dispersions described herein. Nonlimiting examples of diisocyanate compounds include aromatic, cycloaliphatic, or aliphatic diisocyanates such as, but not limited to, α,α,α,α-tetramethylxylene diisocyanate (TMXDI™), 3,5,5-trimethyl-1-isocyanato-3-isocyanatomethylcyclohexane isophorone diisocyanate (IPDI) and derivatives thereof, tetramethylene diisocyanate, hexamethylene diisocyanate (HDI) and derivatives thereof, 2,4-toluene diisocyanate, 2,6-toluene diisocyanate, isophorone diisocyanate, m-isopropenyl-α,α-dimethylbenzyl isocyanate (TMI), 4,4′-dicyclohexylmethane diisocyante (H12MDI), benzene 1,3-bis(1-iscyanato-1-methylethyl), 1-5 naphthalene diisocyanate (NDI), pphenylene diisocyanate (PPDI), trans-cyclohexane-1,4-diisocyanate (TMI), bitolylene diisocyanate (TODI), 4,4′-diphenylmethane diisocyanate, 4,4′-diphenyl dimethyl methane diisocyanate, dialkyl diphenyl methane diisocyanate, tetraalkyl diphenyl methane diisocyanate, 4,4′-dibenzyl diisocyanate, 1,3-phenylene diisocyanate, 1,4-phenylene diisocyanate, the isomers of tolylene diisocyanate, 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanatomethyl-3-isocyanato-1,5,5-trimethyl cyclohexane, chlorinated and brominated diisocyanates, phosphorus-containing diisocyanates, 4,4′-diisocyanatophenyl perfluoroethane, tetramethoxy butane-1,4-diisocyanate, butane-1,4-diisocyanate, hexane-1,6-diisocyanate, dicyclohexyl methane diisocyanate, cyclohexane-1,4-diisocyanate, ethylene diisocyanate, phthalic acid-bis-isocyanatoethyl ester. Additional nonlimiting examples of diisocyanates include trimethyl hexamethylene diisocyanate, 1,4-diisocyanatobutane, 1,2-diisocyanatododecane, dimer fatty acid diisocyanate, and partly masked polyisocyanates. These isocyanates can be used for the formation of self-crosslinking PUs. Diisocyanates, such as those described herein, can be used alone or in a mixture of isocyanates.

### Catalysts

Catalysts can be used for polymerization of polyols and isocyanates to form PU compositions. Nonlimiting examples of PU catalysts include tin catalysts, dibutyl tin dilaurate (DBTDL), dibutyltin diacetate (DBTDA), triethylenediamine (TEDA or DABCO), dimethylcyclohexylamine (DMCHA), dimethylethanolamine (DMEA), and bis-(2-dimethylaminoethyl)ether (A-99), titanium(IV) isopropoxide tin carboxylates, bismuth-based catalysts, bismuth carboxylates, zinc carboxylates, zirconium carboxylates, nickel carboxylates, metal carboxylates, and amines. In some embodiments, catalysts are not required for polymerization. For example, heat can be used to accelerate the polymerization reaction.

### Chain Extenders

Chain extenders are typically low molecular weight compounds, such as hydroxyl amines, glycols, or diamines, that facilitate polymerization. Chain extenders greatly influence the mechanical response (rigidity and flexibility) of the PU. Non-limiting examples of chain extenders include ethylene glycol, diethylene glycol, triethylene glycol, tetraethylene glycol, propylene glycol (1,3-propanediol), dipropylene glycol, tripropylene glycol, neopentyl glycol, alkyl diols of varying lengths (HO—(CH₂)ₚ—OH; where p is an integer greater than 1), 1,3-butanediol, 1,4-butanediol, 1,6-pentanediol, 1,6-hexanediol, 1,2,6-hexanetriol, 1,4-cyclohexanedimethanol, ethylenediamine, ethanolamine, diethanolamine, N-methyl diethanolamine (MDEA), phenyldiethanolamine, triethanolamine, isosorbide, glycerol, trimethylolpropane, pentaerythritol, diethyltoluenediamine, dimethylthiotoluenediamine, N,N,N′,N′-tetrakis, glycerol, monoacylglycerol, diacylglycerol, and hydroquinone bis(2-hydroxyethyl) (HQEE). Chain extenders can be bio-based or produced through bio-based or other renewable means.

### Polyols

### Natural Oil Polyols

Natural oil polyols (NOPs), natural oils having two or more hydroxyl moieties, can be obtained directly as a product from plants, other vegetation, microbes, or animals. An average hydroxyl value (OH #) of NOPs can range from about 1 to about 230, from about 10 to about 175, or from about 25 to about 140. Castor oil from the castor oil plant, rich in ricinoleic acid, is an example of a natural oil polyol. Natural oil polyols can also be produced through chemical modification of natural oils.

Sources of natural oils that can be used to make natural oil polyols include, but are not limited to, microalgal oil, algal oil, soybean oil, safflower oil, castor oil, linseed oil, corn oil, sunflower oil, olive oil, canola oil, sesame oil, grapeseed oil, sea buckthorn oil, almond oil, argan oil, avocado oil, babassu oil, buffalo gourd oil, hazelnut oil, walnut oil, pecan oil, pistachio oil, macadamia nut oil, peanut oil, meadowfoam seed oil, hemp seed oil, coconut oil, cottonseed oil, palm oil, rapeseed oil, tea tree oil, lallemantia oil, eucalyptus oil, palm oil, palm kernel oil, hibiscus seed oil, perilla seed oil, pequi oil, pine nut oil, poppyseed oil, prune kernel oil, pumpkin seed oil, quinoa oil, ramtil oil, rice bran oil, tea tree oil, thistle oil, wheat germ oil, tung oil, and fish oil. TABLE 1 shows the fatty acid composition of several natural oils suitable for producing NOPs.

TABLE 1

| | | | | | | | | | | Mid |
|---|---|---|---|---|---|---|---|---|---|---|
| Fatty | Sea | Grape | Macadamia | Soy | | | Meadow | Hemp | High | Oleic |
| Acid | Buckthorn | seed | nut | bean | Argan | Castor | foam | seed | Oleic | Algal |
| (%) | Oil | Oil | Oil | Oil | Oil | Oil | Oil | Oil | Algal Oil | Oil |
| C14:0 | 0.4 | 0.1 | 0.7 | 0.1 | 0.2 | 0.0 | 0.0 | 0.1 | 0.4 | 0.9 |
| C16:0 | 30.5 | 4.3 | 8.4 | 11.0 | 13.2 | 1.0 | 0.1 | 6.1 | 2.1 | 18.3 |
| C16:1 | 30.5 | 0.2 | 20.4 | 0.1 | 0.1 | 0.0 | 0.0 | 0.1 | 0.5 | 0.4 |
| C18:0 | 1.0 | 2.0 | 3.3 | 4.5 | 5.8 | 1.2 | 0.1 | 2.5 | 0.9 | 4.9 |
| C18:1 | 22.3 | 58.3 | 54.4 | 24.7 | 45.8 | 2.9 | 0.3 | 10.3 | 87.7 | 64.4 |
| C18:1 | 8.2 | 2.5 | 3.4 | 1.3 | 0.0 | 0.4 | 0.0 | 0.8 | 0.0 | 0.0 |
| C18:2 | 3.7 | 22.1 | 2.1 | 51.3 | 33.6 | 4.3 | 0.1 | 55.0 | 6.3 | 9.3 |
| C18:3 | 0.0 | 0.0 | 0.0 | 0.0 | 0.0 | 0.0 | 0.0 | 0.0 | 0.4 | 0.2 |
| gamma | | | | | | | | | | |
| C18:3 | 2.2 | 7.8 | 0.1 | 5.3 | 0.1 | 0.5 | 0.1 | 0.0 | 0.0 | 0.7 |
| alpha | | | | | | | | | | |
| C20:0 | 0.3 | 0.6 | 2.8 | 0.5 | 0.4 | 0.1 | 0.7 | 17.4 | 0.0 | 0.2 |
| C20:1 | 0.0 | 0.1 | 0.0 | 0.1 | 0.0 | 0.1 | 0.0 | 1.5 | 0.0 | 0.0 |
| C20:1 | 0.0 | 0.0 | 0.0 | 0.0 | 0.0 | 0.0 | 64.5 | 0.9 | 0.0 | 0.0 |
| C20:1 | 0.2 | 1.2 | 2.6 | 0.3 | 0.5 | 0.3 | 0.0 | 0.0 | 0.0 | 0.0 |
| 12-OH- | 0.0 | 0.0 | 0.0 | 0.0 | 0.0 | 88.0 | 0.0 | 0.0 | 0.0 | 0.0 |
| C18:1 | | | | | | | | | | |

Polyols derived from highly unsaturated oils have high hydroxyl numbers compared to polyols derived from oils having lower saturation levels. High hydroxyl number increases the versatility of a polyol for producing a wide range of polyurethane materials, such as PUDs. A polyol described herein can have a hydroxyl number of from 125 to 165, from 145 to 165, from 135 to 160, or from 140 to 155. For example, a polyol described herein can have a hydroxyl number of 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, or 165. In some embodiments, the hydroxyl number of a polyol can be determined by ASTM E1899.

### Microbial Oil Polyols

Microbial oil produced by oleaginous microbes has numerous advantages, including, but not limited to, improved production efficiency and a TAG composition that is enhanced for improved control of chemistries for generating polyols. These characteristics result in a greater degree of hydroxyl group functionality relative to oils with greater TAG heterogeneity (hence, lower purity) and/or diversity (e.g., oilseed or plant derived oils).

Polyols derived from a microbial oil can be particularly useful for producing PU materials. For example, microbial oils can have relatively low TAG diversity, low fatty acid diversity, and the majority of fatty acids present in the microbial oil can be unsaturated fatty acids. A higher ratio of unsaturated fatty acid to saturated fatty acid allows for increased chemical reactivity at the double bonds. Microbial oils having low TAG diversity and a high proportion of unsaturated fatty acids can be especially desirable in PU production. Polyols derived from these oils to can have a greater percentage of fatty acids that participate in crosslinking reactions with isocyanates. Unlike unsaturated fatty acids, saturated fatty acids do not contain carbon-carbon double bounds and cannot participate in crosslinking reactions with isocyanates. Thus, polyols generated from chemical modification of unsaturated fatty acids from microbial oil can yield PU materials having superior properties.

Polyols derived from microbial oils can be particularly useful for producing PUDs. Use of vegetable oil-based polyols can be challenging for the synthesis of waterborne PU dispersions because the high hydroxyl functionality of these polyols can lead to gelation and higher crosslinking of the PU prepolymers. High crosslinking can interfere with the dispersibility of the PU prepolymers in water. Microbial oils having low TAG diversity and a high proportion of monounsaturated fatty acids can desirable in production of PUDs, including waterborne PUDs. The uniformity of these polyol structures combined with inherent lower functionality than traditional vegetable oil derivatives enables predictability in preparing higher molecular weight diols, as well as the opportunity to build long chain, linear polyols that are advantageous for elastomeric and flexible polyurethanes.

The complexity and physical properties of a triglyceride oil can be evaluated by the fatty acid profile, and the triacylglycerol (TAG) profile. The fatty acid profile is a measure of fatty acid composition. The fatty acid profile can be determined by subjecting oils to transesterification to generate fatty acid methyl esters and subsequently quantitating fatty acid type by Gas Chromatography with Flame Ionization Detector (GC-FID). Because fatty acids are arrayed at three positions along the glycerol backbone in the triglyceride molecule, the number of possible distinct regioisomers of TAG molecules can be defined by the number of fatty acid species in the oil raised to the third power.

Soybean oil, for example, contains 6 fatty acids. Thus, in theory, soybean oil can contain as many as 216 or (6³) TAG regioisomers. The actual number of TAG regioisomers in soybean oil is substantially smaller (approximately 37), as soybean oil is a complex, heterogeneous material with each TAG species having varying levels of unsaturated fatty acids. Similarly, soybean oil-derived polyols are highly heterogeneous, which can negatively impact the physical properties of the final polymer produced therefrom. Thus, oils that are very low in saturates and high in a particular species of unsaturated fatty acid are most suitable for generating NOPs since virtually all fatty acids contained in the triglyceride oil can participate in crosslinking with isocyanate moieties.

Additionally, if the fatty acid profile can be modulated such that the concentration of a particular species of monounsaturated or polyunsaturated fatty acids can be significantly increased from the concentration in the native oil, there can be an overall decrease in the diversity of TAG species present in the resulting oil. The net effect is that a higher number of hydroxylated fatty acids and a higher proportion of all TAG species can participate in urethane chemistries. For example, in two cultivars of peanut oil, N-3101 and H4110, oleic acid content was increased from 46% to 80% and total monounsaturated and polyunsaturated fatty acids was increased only subtly, from 77% to 84%, respectively. According to the TAG profile of the resulting oils derived from the two cultivars, approximately 95% of all TAG species are accounted for in just eight regioisomers in cultivar H4110 and 23 regioisomers in cultivar N-3101. Thus, triglycerides that are significantly enriched in a single species result in more homogeneous substrates for subsequent chemical manipulations and incorporation into materials.

Organisms can be genetically modified to produce natural oils enriched for unsaturation, hydroxylation, epoxidation, or other moieties that are beneficial in producing a natural oil polyol.

In some embodiments, a triglyceride oil described herein is derived from a microbial oil. Microbial oils can be produced using oleaginous microbes. Oleaginous microbes can refer to species of microbes having oil contents in excess of 20% on a dry cell weight basis. These microbes are uniquely suited for generating highly pure, natural oil polyols with hydroxyl functionality. Oleaginous microbes have also been proven extremely facile for genetic modification and improvement.

Indeed, these improvements can occur on time scales that are greatly accelerated relative to what can be achieved in higher plant oilseeds. Oleaginous microbes offer tremendous utility in generating large quantities of triglyceride oils in short periods of time. In as little as 48 hours, appreciable oil production of about 30-40% oil (dry cell weight) can be obtained, whereas typical production requires 120 hours or more to achieve 70-80% oil (dry cell weight).

Furthermore, because these microbes can be heterotrophically grown using simple sugars, the production of these triglyceride oils can be divorced from the traditional constraints imposed by geography, climate, and season that constrain triglyceride oil production from oilseed crops.

Recombinant DNA techniques can be used to engineer or modify oleaginous microbes to produce triglyceride oils having desired fatty acid profiles and regiospecific or stereospecific profiles. Fatty acid biosynthetic genes, including, for example, those encoding stearoyl-ACP desaturase, delta-12 fatty acid desaturase, acyl-ACP thioesterase, ketoacyl-ACP synthase, and lysophosphatidic acid acyltransferase can be manipulated to increase or decrease expression levels and thereby biosynthetic activity. These genetically engineered microbes can produce oils having enhanced oxidative, or thermal stability, rendering a sustainable feedstock source for various chemical processes. The fatty acid profile of the oils can be enriched in midchain profiles or the oil can be enriched in triglycerides having specific saturation or unsaturation contents. In some embodiments, a triglyceride oil described herein is produced by recombinant techniques or genetic engineering. In some embodiments, a triglyceride oil described herein is not produced by recombinant techniques or genetic engineering.

Among microalgae, several genera and species are suitable for producing triglyceride oils that can be converted to polyols including, but not limited to, Chlorella sp., Pseudochlorella sp., Prototheca sp., Arthrospira sp., Euglena sp., Nannochloropsis sp. Phaeodactylum sp., Chlamydomonas sp., Scenedesmus sp., Ostreococcus sp., Selenastrum sp., Haematococcus sp., Nitzschia, Dunaliella, Navicula sp., Pseudotrebouxia sp., Heterochlorella sp., Trebouxia sp., Vavicula sp., Bracteococcus sp., Gomphonema sp., Watanabea sp., Botryococcus sp., Tetraselmis sp., and Isochrysis sp.

Among oleaginous yeasts, several genera are suitable for producing triglyceride oils that can be converted to polyols including, but not limited to, Candida sp., Cryptococcus sp., Debaromyces sp., Endomycopsis sp., Geotrichum sp., Hyphopichia sp., Lipomyces sp., Pichia sp., Rodosporidium sp., Rhodotorula sp., Sporobolomyces sp., Starmerella sp., Torulaspora sp., Trichosporon sp., Wickerhamomyces sp., Yarrowia sp., and Zygoascus sp.

Among oleaginous bacteria there are several genera and species which are suited to producing triglyceride oils that can be converted to polyols including, but not limited to Flavimonas oryzihabitans, Pseudomonas aeruginosa, Morococcus sp., Rhodobacter sphaeroides, Rhodococcus opacus, Rhodococcus erythropolis, Streptomyces jeddahensis, Ochrobactrum sp., Arthrobacter sp., Nocardia sp., Mycobacteria sp., Gordonia sp., Catenisphaera sp., and Dietzia sp.

Oleaginous microbes can be cultivated in a bioreactor or fermenter. For example, heterotrophic oleaginous microbes can be cultivated on a sugar-containing nutrient broth.

Oleaginous microbes produce microbial oil having triacylglycerides or triacylglycerols. These oils can be stored in storage bodies of the cell. A raw oil can be obtained from microbes by disrupting the cells and isolating the oil. For example, microbial oil can be obtained by providing or cultivating, drying and pressing the cells. Microbial oils produced can be refined, bleached, and deodorized (RBD) prior to use. Microbial oils can be obtained without further enrichment of one or more fatty acids or triglycerides with respect to other fatty acids or triglycerides in the raw oil composition.

### Generating NOPs

In the process of producing NOPs from natural sources, the hydroxyl group functionality can be introduced via a chemical conversion of a triglyceride oil. This conversion requires the presence of a double bond on the acyl moiety of the fatty acid, which can be accomplished using several different chemistries including, for example epoxidation, ozonolysis, and hydroformylation and reduction.

Epoxidation and subsequent ring opening across the C═C bonds of an acyl chain can be carried out using a variety of reagents including, for example, water, hydrogen, methanol, ethanol, propanol, isopropanol, or other polyols. Ring opening can be facilitated by reaction with an alcohol, including, for example, β-substituted alcohols.

Hydroformylation with synthesis gas (syngas) can be carried out using rhodium or cobalt catalysts to form the aldehyde at the olefinic group. The aldehyde can subsequently undergo reduction to an alcohol in the presence of hydrogen and a nickel catalyst to generate the polyol.

The hydroformylation chemistry results in the preservation of fatty acid length and formation of primary hydroxyl group moieties. Primary hydroxyl group functionalities can be desirable in some PU applications due to increased reactivity compared to secondary hydroxyl group moieties. Hydroxyl groups introduced to olefinic groups in the acyl can participate in subsequent downstream chemistries, i.e., reaction with an isocyanate moiety to form a urethane linkage or reaction with methyl esters to form polyesters. Saturated fatty acids which do not contain double bonds cannot participate in crosslinking reactions with isocyanates. Hence, saturated fatty acids can compromise the structural integrity and degrade performance of the polymer produced therefrom.

In some embodiments, polyols described herein have a substantial proportion of primary hydroxyl groups. In some embodiments, some or most of the polyols described herein contain secondary hydroxyl groups. In some embodiments, polyols can be modified to increase the proportion of primary hydroxyl groups.

Derivatives of natural oils can serve as the starting point for NOPs. Non-limiting examples of natural oil derivatives suitable for producing NOPs include fatty acids, fatty acid methyl esters, fatty acid ethyl esters, hydroxylated fatty acids, hydroxylated fatty methyl esters, and hydroxylated fatty ethyl esters.

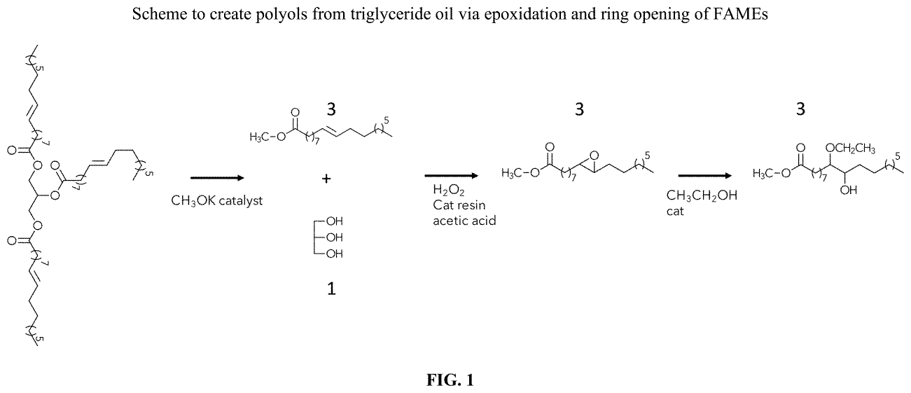

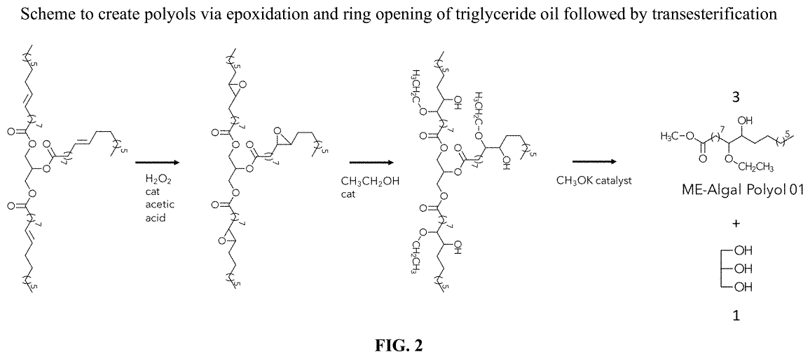

Fatty acid methyl esters can be generated through ester chemistry. For example, the triglyceride can be cleaved through transesterification into fatty acid methyl esters (FAMEs) and glycerol as shown in FIG. 1. In turn, FAMEs can be subjected to epoxidation and ring opening, for example, to create FAMEs of alcohols. Alternatively, as illustrated in FIG. 2, polyols can first be generated from a triglyceride through epoxidation and ring opening, for example, followed by transesterification, into FAMEs of alcohols and glycerol. Glycerol and potassium methoxide catalyst can be removed by washing with water.

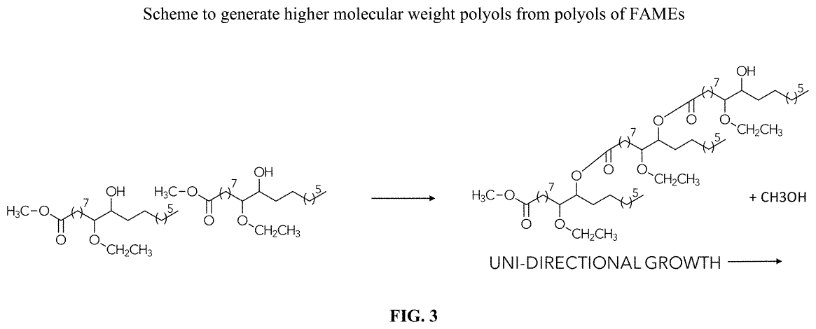

Catalysts, including potassium methoxide (KOCH₃), 1,5,7-triazabicyclo[4.4.0]dec-5-ene (TBD), Titanium(IV) isopropoxide (TIP), dibutyltin dilaurate (DBTDL), tris(pentafluorophenyl)borane (BCF), and potassium tert-butoxide, among others, can be utilized to re-esterify ester groups to alcohol moieties. The dual functionality of alcohol FAMEs can be used to create polymer networks using only the methyl esters of the alcohol as shown in FIG. 3. Due to the polarity of the molecules (ester on one end and alcohol at the other end), the resulting polymer networks can elongate unidirectionally, are linear, and terminate in a single hydroxyl group.

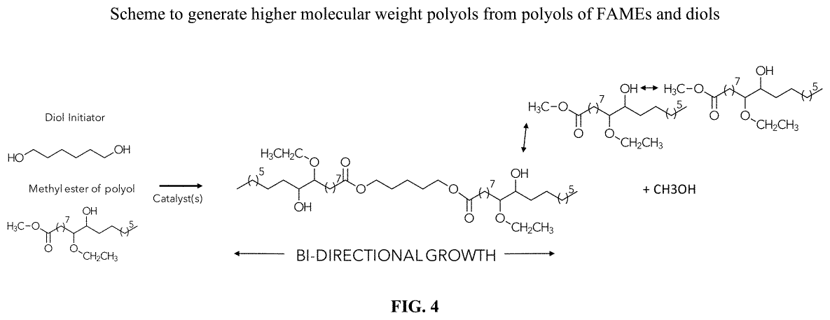

Polymer networks can also be elongated bi-directionally through incorporation of a diol as shown in FIG. 4. Non-limiting examples of diols for useful for building polymer networks include propylene glycol, 1,4-butanediol, 1,3-propanediol, and 1,6-hexanediol. Diols can be produced using microbial hosts.

Hyperbranched polyols can be prepared to achieve a range of properties, such as molecular weight, viscosity, branching, and reactivity. For example, hyperbranched polyols can combine with isocyanates, ionogenic molecules, or hydrophobic compounds to impart beneficial surface effects to substrates.

### Waterborne Polyurethane Dispersions

Aqueous (or waterborne) PUDs comprise a binary colloidal system in which PU particles are dispersed in a continuous aqueous media. Methods of producing PUDs include the acetone process, the prepolymer mixing process, the melt dispersion process, and the ketimine/ketazine process.

PUDs can be prepared by forming an isocyanate-terminated prepolymer, dispersing the prepolymer in an aqueous phase, and then forming the polyurethane and/or urea polymer by chain-extending the prepolymer. The prepolymer itself can be made by reacting an excess of a polyisocyanate with a polyol.

The PUDs described herein can be formed by a two-step reaction process. In a first step, a hydrophobic soft segment precursor can be reacted with one or more hard segment precursors to form a PU prepolymer. The hard segment precursors in the first step can include a first hard segment precursor as an isocyanate (e.g., diisocyanate) and a hydrophilic second hard segment precursor as a polyol (e.g., diol) that additionally includes an ionic group. The resulting polyurethane prepolymer includes (i) hydrophobic soft segments and hydrophilic second hard segments linked via urethane group reaction products with the first hard segment precursor, and (ii) terminal isocyanate functional groups (e.g., resulting from terminal first hard segment precursors with an unreacted isocyanate group). In some embodiments, the content of the said hydrophilic functional polyols is from 2 to 15% by weight or from 3 to 8% by weight based on the amount by weight of all the monomers in the reaction mixture.

In a second step, the PU prepolymer can be reacted with an additional chain-extending hard segment precursor. The chain-extending hard segment precursor can be a third hard segment precursor that is reactive with the terminal isocyanate functional groups of the prepolymer (e.g., a diamine or polyamine chain extender forming urea/carbamide links between prepolymer segments). The resulting polymer can have a structure in which PU prepolymer units are linked via the chain extender and is capable of forming a dispersion of the PU polymer particles in an aqueous medium.

Nonlimiting examples of PUD additives include surfactants, pH adjusters, crosslinkers, wetting agents, waxes, wax extenders, matting agents, viscosity regulators, inorganic and organic pigments, dyes, leveling agents. Suitable surfactants include anionic, cationic, nonionic, N-oxides, and amphoteric surfactants. Examples of such other additives include processing aids, foaming agents, lubricants, anti-stains, and the like.

Ionogenic molecules (known as ionogens or ionomers) are molecules composed of repeat units of electrically neutral repeating units and ionizable units covalently bonded to the polymer backbone. To achieve the water dispersibility of PUs described herein, PUD formulations described herein can include an ionogenic molecule that imparts hydrophilic characteristics to the prepolymer by nature of the charged moiety of the ionogenic molecule. In the case of anionomers, the charged moiety can be carboxylate or sulfonate groups. In the case of cationomers, the charged moiety can be ammonium groups. These hydrophilic groups allow the prepolymer to be easily water-dispersible and facilitate the formation of fine prepolymer droplets to form a stable polymer dispersion. Nonlimiting examples of ionogenic molecules include N-methyl diethanolamine (MDEA), dimethylolpropionic acid (DMPA), and dimethylolbutanoic acid (DMBA). MDEA is a cationomer, whereas DMPA and DMBA are both anionomers.

Polyols can also be combined with hydrophobic compounds that increase the water resistant properties of the resulting PUD. Nonlimiting examples of such hydrophobic compounds include methyl cinnamate, cinnamic acid, methyl ferulate, and saturated or unsaturated aromatic carboxylic acids. Hydrophobic monomers can be bio-based or produced through renewable means. In some embodiments, hydrophobic monomers are of a renewable origin or character.

PUDs produced from polyols described herein can have improved hydrophobicity, stability, durability, stain resistance, or abrasion resistance over PU materials produced from petroleum feedstocks or conventional vegetable oils, such as those derived from plant oilseed crops.

The PUDs described herein can be applied to substrates treated with a compound or composition of the present invention as described above. Suitable substrates include fibrous substrates. The fibrous substrates include fibers, yarns, fabrics, fabric blends, textiles, nonwovens, paper, leather, and carpets. These are made from natural or synthetic fibers including cotton, cellulose, wool, silk, rayon, nylon, aramid, acetate, acrylic, jute, sisal, sea grass, coir, polyamide, polyester, polyolefin, polyacrylonitrile, polypropylene, polyaramid, or blends thereof. Fabric blends are fabrics made of two or more types of fibers. Typically, these blends are a combination of at least one natural fiber and at least one synthetic fiber, but also can include a blend of two or more natural fibers or of two or more synthetic fibers, as well as spunbonded-meltblown-spunbonded nonwovens. The treated substrates described herein have excellent water repellency and optionally stain release properties.

Textiles can be natural, synthetic, or semi-synthetic. The textiles can be of animal or plant origin, or can be purely synthetic. Non-limiting examples of textiles include fabrics, yarns, knits, fibers, wovens, non-wovens, clothing, garments, bedding, domestic linen, and upholstery. A textile can be treated prior with a coloring agent such as a dye or a pigment. Non-limiting examples of natural textiles include: burlap; calico; camel hair; canvas; cashmere; cheesecloth; chiffon; corduroy; cotton; denim; doeskin; double gauze; dowlas; drill; dugget; duck cloth; felt; fishnet; flannel; fleece; foulard; fur; fustian; gabardine; gauze; ghalamkar; haircloth; hemp; herringbone; himroo; hodden; jute; kemp; lace; lawn cloth; leather; textile linen; lensey-woolsey; longcloth; Mackinaw cloth; madapolam; madras; milliskin; mockado; mohair; moire; moleskin; monk's cloth; moquette; mouflon; muslin; natural grosgrain; natural melton; natural mesh; oilskin; organdy; organza; osnaburg; Ottoman; Oxford; paduasoy; polyester; pongee; poplin; quilting; Russel cord; satin; seersucker; sharkskin; silk; single gauze; spandex; suede; terrycloth; triple gauze; tweed; twill; velour; velvet; waterproof breathable fabrics; and wool. In certain embodiments, the textile is chosen from cotton and wool. Non-limiting examples of synthetic textiles include Dyneema®; Gannex; Gore-Tex™; grosgrain; Kevlar™; synthetic melton; synthetic mesh; microfiber; milliskin; moire; Nomex™; nylon; rayon; silnylon; synthetic grosgrain; synthetic melton; synthetic mesh; and synthetic plush. Non-limiting examples of semi-synthetic textiles include semi-synthetic grosgrain; semi-synthetic melton; semi-synthetic mesh; and semi-synthetic plush.

Materials treated with formulations described herein can include, for example, apparel and footwear, backpacks, tents, tarps, and outdoor equipment. Examples of apparel suitable for use with the formulations described herein can include jackets, rain jackets, snow jackets, coats, shells, pants, bibs, and gloves. Examples of footwear suitable for treatment with formulations described herein include hiking boots, work boots, approach shoes, trail shoes, and running shoes.

Waterborne PUDs described herein can be applied to substrates by a variety of application methods. Nonlimiting examples of application methods include application by exhaustion, foam, flex-nip, nip, pad, kiss-roll, beck, skein, winch, liquid injection, overflow flood, roll, brush, roller, spray, dipping, padding, immersion, and the like.

PUDs described herein can be diluted with water to achieve a desired activity level and then applied onto a fiber or fabric textile. Removal of any excess emulsion can be achieved by using a mangle, centrifugal separator, or the like to control the amount of liquid absorbed by the textile. Drying can be effected with or without heat. Depending upon the particular textile being treated, when drying is performed with heat, the temperature can range from about 70° C. to about 180° C., and the time of heating from about 1 minute to about 30 minutes. After removal of excessive dispersion, subsequent heating to promote curing can be performed. Cure temperatures can range from about 120° C. to about 200° C. and cure time can range from about 1 minute to about 30 minutes. Upon curing, the resultant condensation product can impart durability, water repellency, and softness to the textile.

In some embodiments, a PUD formulation described herein has a bio-based content of about 50% to about 60% as assessed by ASTM 6866. For example, a PUD formulation described herein has a bio-based content of at least 50%, at least 51%, at least 52%, at least 53%, at least 54%, at least 55%, at least 56%, at least 57%, at least 58%, at least 59%, or at least 60%. In some embodiments, a PUD formulation described herein has a bio-based content of about 50%, about 51%, about 52%, about 53%, about 54%, about 55%, about 56%, about 57%, about 58%, about 59%, or about 60%.

A PUD formulation described herein can be characterized by solids content. Solids content is the mass of the material remaining after drying, e.g., at 70° C. for about 2 hr. Solids content can be calculated as follows: (dry mass of the PUD/starting mass of the PUD)×100. For example, a PUD formulation described herein has a solids content of at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, or at least 40% on a weight percentage basis. In some embodiments, a PUD formulation described herein has a bio-based content of about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40% on a weight percentage basis.

A PUD formulation described herein can be characterized by hard segment content. Hard segment content can contribute to moisture retention. Hard segment content can be determined from the total soft segment content of a PUD. The total soft segment content can be calculated from the polyol-isocyanate interactions in the PUD as follows: (moles of the polyol×MW of the polyol)+(moles of the isocyanate×MW of the isocyanate). Hard segment content can then be calculated by subtracting the total soft segment content from the total mass of the raw materials as follows: (MW of the ionomer×moles of the ionomer)+(MW of the neutralizing component×moles of the neutralizing component)+(MW of the chain extender×moles of the chain extender). In cases where no chain extender is used in the formulation, the chain extender component is omitted in the hard segment content calculation. For example, a PUD formulation described herein has a hard segment content of at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, or at least 50% on a weight percentage basis. In some embodiments, a PUD formulation described herein has a hard segment content of about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50% on a weight percentage basis.

Stability of a PUD can be characterized based on whether the PUD remains dispersed in solution, e.g., aqueous solution. Stability can be assessed by centrifugation in a conical test tube of a PUD sample for about 30 minutes at about 3,000 rpm and visual inspection for the presence of solid precipitates on the sides and bottom of the tube.

A PUD formulation described herein can be characterized by viscosity at ambient temperature (e.g., about 25° C.). Viscosity can be determined using a rheometer, e.g., TA Instruments AR 2000 rheometer with a 40 mm 2-degree steel cone at 25° C. For example, a PUD formulation described herein has a viscosity of less than 0.5 mPa·s, less than 1 mPa·s, less than 2 mPa·s, less than 3 mPa·s, less than 4 mPa·s, less than 5 mPa·s, less than 6 mPa·s, less than 7 mPa·s, less than 8 mPa·s, less than 9 mPa·s, or less than 10 mPa·s. In some embodiments, a PUD formulation described herein has a viscosity of from about 1 mPa·s to about 10 mPa·s, from about 4 mPa·s to about 10 mPa·s, or about 4 mPa·s to about 8 mPa·s.

A PUD formulation described herein can be characterized by particle size distribution. Particle size distribution of the PUDs can be measured by dynamic light scattering, e.g., using a Zetasizer device. For example, a PUD formulation described herein can have a particle size distribution from about 70 nm to about 100 nm. In some embodiments, a PUD formulation described herein has a maximum particle size of less than 200 nm, less than 100 nm, less than 90 nm, less than 80 nm, or less than 70 nm.

Polydispersity index (PDI) can be used to describe the width or spread of the particle size distribution. PDI can also be measured by dynamic light scattering, e.g., using a Zetasizer device. PDI value can range from 0 to 1, where the colloidal particles with PDIs less than 0.1 implies monodisperse particles and colloidal particles with PDIs more than 0.1 imply polydisperse particle size distributions. In some embodiments, a PUD formulation described herein has a PDI of less than 0.1, less than 0.15, less than 0.2, less than 0.3, less than 0.4, or less than 0.5. In some embodiments, a PUD formulation described herein has a PDI of about 0.10, about 0.11, about 0.12, about 0.13, about 0.14, about 0.15, about 0.16, about 0.17, about 0.18, about 0.19, or about 0.20.

A PUD formulation described herein can be characterized by hydrophobicity or water repellency when applied as a film onto a substrate. Water repellency can be assessed by water contact angle measurements and water absorption. The contact angle is the angle where a liquid interface meets a solid surface. Water contact angle can be used to quantify the wettability of a solid surface (PUD film) by a liquid (water). Generally, the greater the contact angle, the higher the degree of hydrophobicity of the surface. Water contact angles can be determined by applying a thin film of a liquid PUD onto a glass slide. After drying, contact angle measurements can be performed with a Drop Shape Analyzer DSA25. These devices are designed to determine the wettability as well as the surface tension of a PUD film.

In some embodiments, a PUD film described herein has a water contact angle of 60 to 70 degrees, 70 to 80 degrees, 80 to 90 degrees, 60 to 100 degrees, 70 to 100 degrees, 80 to 100 degrees, or 90 to 100 degrees. In some embodiments, a PUD film described herein has a water contact angle of greater than 60 degrees, greater than 65 degrees, greater than 70 degrees, greater than 75 degrees, greater than 80 degrees, greater than 85 degrees, greater than 90 degrees, greater than 95 degrees, or greater than 100 degrees. In some embodiments, a PUD film described herein has a water contact angle of about 60 degrees, about 65 degrees, about 70 degrees, about 75 degrees, about 80 degrees, about 85 degrees, about 90 degrees, about 95 degrees, or about 100 degrees.

Water absorbency of a PUD film can be determined gravimetrically. PUDs can be casted in Teflon molds and cured. The dried PUD films of known weight (m₀) can be immersed in water at room temperature for 24 h. Excess water can be removed by wiping with a paper towel prior to weighing again (m₁). The percentage of water absorption (WA) can be calculated as follows: WA=((m₁−m₀)/m₀)×100.

In some embodiments, a PUD formulation described herein has a water absorption of 0% to about 5%, 0% to about 4%, 0% to about 3%, 0% to about 2%, or 0% to about 1%. In some embodiments, a PUD formulation described herein has a water absorption of less than 10%, less than 9%, less than 8%, less than 7%, less than 6%, less than 5%, less than 4%, less than 3%, less than 2%, or less than 1%.

Glass transition temperature (T_{g}) of a PUD formulation can be assessed by differential scanning calorimetry (DSC). Samples for DSC can be obtained from polymer films (weight of about 10-12 mg). DSC can be carried out on a thermal analyzer in a nitrogen atmosphere. Samples can be cooled to −80° C., then heated to 120° C. with a heating rate of 10° C./min to erase the thermal history of the sample. Samples can then be cooled to −80° C. with a cooling rate of 10° C./min, and heated again to 120° C. with heating rate of 10° C./min. In some embodiments, the PUD formulation described herein has a T_{g} of about 0° C. to about 50° C., about 5° C. to about 10° C., about 10° C. to about 20° C., about 20° C. to about 30° C., about 30° C. to about 40° C., or about 40° C. to about 50° C.

PUD formulations can also be characterized by mechanical testing, including tensile strength and elongation at break testing. For mechanical testing, PUD formulations can be casted in Teflon molds and cured to produce PUD films. Mechanical properties of the films can be analyzed by using an Instron Universal Testing Machine with crosshead speed of 50 mm/min. Rectangular samples of 60×8 mm² (length×width) can be used.

In some embodiments, a PUD formulation described herein has a tensile strength of about 0.1 MPa to about 20 MPa, about 1 MPa to about 10 MPa, about 5 MPa to about 10 MPa, about 10 MPa to about 15 MPa, or about 10 MPa to about 20 MPa. For example, a PUD film described herein has a tensile strength of about 1 MPa, about 2 MPa, about 3 MPa, about 4 MPa, about 5 MPa, about 6 MPa, about 7 MPa, about 8 MPa, about 9 MPa, about 10 MPa, about 11 MPa, about 12 MPa, about 13 MPa, about 14 MPa, about 15 MPa, about 16 MPa, about 17 MPa, about 18 MPa, about 19 MPa, or about 20 MPa. Tensile strength of a PUD film can be assessed by ASTM D638.

In some embodiments, the PUD film described herein has an elongation at break of greater than 100%, greater than 200%, greater than 300%, greater than 400%, greater than 500%, greater than 600%, greater than 700%, greater than 800%, greater than 900%, or greater than 1,000%. For example, a PUD film described herein has an elongation at break of 100% to 200%, 200% to 300%, 300% to 400%, 400% to 500%, 500% to 600%, 600% to 700%, 700% to 800%, 800% to 900%, or 900% to 1,000%. Elongation at break of a PUD film can be assessed by ASTM D638.

### Test Methods

The following test methods and materials can be used to characterize PUDs described herein.

Test Method 1—Water Repellency. The water repellency of a treated substrate can be measured according to the DuPont Technical Laboratory Method as outlined in the TEFLON® Global Specifications and Quality Control Tests information packet. The test determines the resistance of a treated substrate to wetting by aqueous liquids. Drops of water-alcohol mixtures of varying surface tensions are placed on the fabric and the extent of surface wetting is determined visually. The test provides a rough index of aqueous stain resistance. The higher the water repellency rating, the better the resistance the finished substrate has to staining by water-based substances.

Test Method 2—Spray Test. The dynamic water repellency of treated substrates was measured according to the American Association of Textile Chemists and Colorists (AATCC) TM-22. Samples are visually scored by reference to published standards, with a rating of 100 denoting no water penetration or surface adhesion. A rating of 90 denotes slight random sticking or wetting without penetration; lower values indicate progressively greater wetting and penetration.

Test Method 3—Stain Release. This test measures the ability of a fabric to release oily stains during home laundering. Treated textiles are placed on a flat surface. Using an eyedropper, 5 drops of MAZOLA® corn oil or mineral oil (0.2 mL) are placed onto the fabric to form 1 drop of oil. A weight (5 lb, 2.27 kg) is placed on top of the oil drop with a piece of glassine paper separating the oil drop. The weight is left in place for 60 seconds. After 60 seconds, the weight and glassine paper are removed. The textiles samples are then washed using an automatic washer on high for 12 min with AATCC 1993 Standard Reference Detergent WOB12 or granular detergent (100 g). The textiles are then dried on high for 45-50 min. Finally, the textiles are evaluated for residual stain of 1 to 5 with 1 having the largest residual stain remaining and 5 being no stain residual was visible.

Test Method 4—Water Resistance (Rain Test) [AATCC 35]: This test measures the resistance to the penetration of water by impact, and thus can be used to predict the probable rain penetration resistance of fabrics. A test specimen, backed by a weighed blotter, is sprayed with water for 5 min under controlled conditions. The blotter is then reweighed to determine the amount of water which has leaked through the specimen during the test.

Test Method 5—Water Resistance (Hydrostatic Pressure Test) [AATCC 127]: This test measures the resistance of a fabric to the penetration of water under hydrostatic pressure. It is applicable to all types of fabrics, including those treated with a water resistant or water repellent finish. Water resistance depends on the repellency of the fibers and yarns, as well as the fabric construction. The results obtained by this method may not be the same as the results obtained by the test methods for resistance to rain or water spray. One surface of the test specimen is subjected to a hydrostatic pressure that is increased at a constant rate until three points of leakage appear on the other surface of the test specimen.

### EXAMPLES

The invention, having been described in detail above, is exemplified in the following examples, which are offered to illustrate, but not to limit, the claimed invention.

### Example 1: Generation of a Natural Oil Polyol Through Epoxidation and Ring-Opening

Natural oil polyols were prepared from an algal oil. To generate an epoxidized algal oil, the reagents and amounts indicated in TABLE 2 were charged in a reactor equipped with a magnetic bar stirrer, thermometer, and neck for addition of chemicals. The mixture was heated to 65° C. upon which hydrogen peroxide was added dropwise. The temperature of the reaction was held below 80° C. for 70 min. The reaction then continued at 70° C. for 7 hrs. Amberlite was removed by filtration, then the mixture was washed with hot, distilled water until a neutral pH was reached. Washing was carried out in a separatory funnel by shaking and the mixture separated into two layers. Water layer (bottom) was removed and the organic layer was dried in a rotary evaporator under vacuum. The epoxidized oil was characterized by standardized methods. Values are given in TABLE 3.

TABLE 2

| Reagent | Amount (g) |
|---|---|
| Algal Oil, Iodine value: I.V. = 88 g I₂/100 g | 200 |
| Hydrogen peroxide (H2O2), 30 wt % in water | 21 |
| Toluene, ≥99.3% | 119 |
| Glacial acetic acid, MW = 60 g/mol | 35 |
| Ion exchange resin Amberlite IR 120H (Aldrich) | 100 |

TABLE 3

| Property (units) | Standard | Value |
|---|---|---|
| Acid number (mg KOH/g) | IUP AC 2.201 | 0.68 |
| Epoxy oxygen content (%) | ASTM D1652, Test method B | 5.01 |
| Hydroxyl number (mg KOH/g) | ASTME1899 | 118.3 |

Polyols were synthesized in a 500-mL, three-neck round bottom flask, equipped with a reflux condenser and a strong mechanical stirrer or magnetic bar stirrer. Alcohol and catalyst were added first into the flask. The mixture was heated to the boiling point of alcohol and the epoxidized algal oil EAO was added over about 5 min from a dropping funnel. The reaction mixture was stirred throughout the reaction. The total reaction time was 30 min. Lewatitte MP-64 (Bayer) was added as a neutralizing agent for the catalyst. The mixture was stirred and left cooling for about 1 hr, up to the neutralization of the acid (checked with the pH paper; pH of about 6). The ion-exchange resin was then separated from the liquid portion by filtration (Fisher brand filter paper P8; porosity—coarse). Alcohol was removed by evaporation (distillation and rotary evaporator), first under low vacuum and then 1 hr of high vacuum at 70-80° C. TABLE 4 lists reagents used in ring opening reactions to produce two algal polyols. TABLE 5 presents properties of the two algal polyols.

TABLE 4

| Reagent (grams) | Polyol l | Polyol 2 |
|---|---|---|
| Epoxidized Algal oil | 150 | 200 |
| Methanol | 91.8 | 0 |
| Ethyl alcohol, absolute, 200 proof, 99.5% | 0 | 173.1 |
| Catalyst (HBF₄, 48 wt % in water) | 0.5 | 0.777 |
| Ion-exchange resin, Lewatitte, MP-64 (Bayer) | 5 | 7 |

TABLE 5

| Property (units) | Standard | Polyol 1 | Polyol 2 |
|---|---|---|---|
| Acid number (mg KOH/g) | IUP AC 2.201 | 0.58 | 0.66 |
| Epoxy oxygen content (%) | ASTM D1652, | 0.01 | 0.03 |
| | Test method B | | |
| Hydroxyl number (mg KOH/g) | ASTM E1899 | 158.15 | 152 |

| | | |
|---|---|---|
| Viscosity (η@25 °C, Pa · s) | 1.99 | 1.87 |

### Example 2: Preparation of a Waterborne Polyurethane Dispersion from an Algal Polyol

Dimethylol butanoic acid (DMBA), isophorone diisocyanate (IPDI), N-methyl-2-pyrrolidone (NMP), Triethylamine (TEA), Ethylenediamine (EDA), and 1,4-butanediol are purchased from Aldrich.

Polyol 1 from EXAMPLE 1 and DMBA (4.5 wt % based on prepolymers) are dissolved in NMP and added to a 1-L round bottomed 4-neck separable flask with a mechanical stirrer and thermometer. The mixture is heated to 90° C. under moderate stirring for 1 hr, cooled to 60° C., followed by the addition of IPDI (NCO/OH ratio of 1.85). The reaction is allowed to proceed at 80° C. for 3 hr to obtain NCO-terminated prepolymers. The change in the NCO value of the reaction mixture is estimated using a standard back titration method. The prepolymer is then cooled to 50° C. and neutralized with TEA. After 30 min, the mixture is cooled to 35° C. and emulsified with deionized water under vigorous stirring. The neutralized prepolymer is chain-extended by the addition of a solution of EDA and 1,4-butanediol (molar ratio 1:1) in water, and the reaction is allowed to continue until the NCO groups reacted completely.

### Example 3: Preparation of a Waterborne Polyurethane Dispersion from an Algal Polyol

Isophorone diisocyanate (IPDI), methyl diethanolamine (MDEA), DBTDL, methyl ethyl ketone (MEK), and acetic acid were purchased from Aldrich.

Polyol 2 from EXAMPLE 1, IPDI, and MDEA were added to a three-necked flask equipped with a mechanical stirrer, condenser, and thermometer. The molar ratio of NCO groups from IPDI was varied from 2.0 to 2.75. The molar ratio of OH groups from Polyol 2 was kept constant at 1.0, while the molar ratio of OH groups from MDEA was varied from 0.95 to 1.7 (corresponding to the NCO molar ratio of IPDI). One drop of DBTDL was added to the reaction mixture. The reaction was first carried out at 80° C. for 10 min and then MEK (50 wt % based on the reactant) was added to reduce the viscosity. After 2 hr reaction, the reactants are then cooled to room temperature and neutralized by the addition of 1.5 equivalents of acetic acid, followed by dispersion at high speed with distilled water to produce a PUD.

### Example 4: Application of Waterborne Polyurethane Dispersions onto a Paper Surface

In a film casting instrument having two polished rolls, a release paper of the type VEZ matte is inserted in front of the rear roll. The distance between the paper and the front roll is adjusted by means of a feeler gauge. This distance corresponds to the (wet) film thickness of the resulting coating and is adjusted to the desired deposition for each coat.

Individual coatings are applied by pouring the PUD of EXAMPLE 2 and 3 onto the gap between the paper and the front roll and pulling the release paper vertically downwards, whereby the corresponding film is formed on the paper. The films are dried at 50° C. for 10 min and at 150° C. for 3 min.

### Example 5: Application of Waterborne Polyurethane Dispersions onto a Textile Surface

The polyurethane dispersions created in EXAMPLE 2 and 3 materials are coated onto polyester nonwoven textiles using a steel knife. The textiles are triple coated and dried in an oven (165° C.) for about 2 min. The thickness of the coated PU layers is about 0.08 mm.

### Example 6: Water Contact Angle Measurements

Contact angle measurements are performed with a device Drop Shape Analyzer DSA25 supplied by KRUSS GmbH (Hamburg, Germany). For measurement, a 30 μL drop of water is placed on the coated samples of EXAMPLE 4 and 5. After 10 seconds the contact angle is recorded. For each sample, this measurement is repeated 5 times.

### Example 7: Generation of a Natural Oil Polyol Through Hydroformylation and Hydrogenation and Characterization Thereof

This example describes the synthesis of an hydroformylated, hydrogenated polyol, denoted Polyol HF1, from algal oil characterized by an Iodine Value (IV) of 88 g I₂/100 g, 91% oleate, 5% linoleate, 1.8% palmitate, and 1.12% other fatty acids.

A 2-L pressure reactor was charged with 450 g of algal oil, 0.45 g of Rh (as acetylacetonato-dicarbonylrhodium(I)), and 2.48 g of triphenylphosphine (TPP) ligand. The vessel was flushed with 4×100 psig syngas and then heated to 90° C. The syngas pressure was maintained at 1,000 psi for 6 hrs followed by cooling of the vessel to room temperature and venting the syngas. The reactor was opened and charged with 225 mL of isopropanol and 45 g of Raney nickel and closed again. The mixture was then flushed with 4×100 psig of hydrogen, and subsequently heated to 110° C. The hydrogen pressure was maintained at 1,000 psi for 5 hrs and the reactor was cooled, opened, and diluted with another 100 mL of isopropanol. The reactor contents were filtered through Celite® to remove the Raney nickel and Rh catalysts. After removing the solvents under vacuum, 480 grams of viscous liquid was obtained. TABLE 6 lists properties of Polyol HF1.

TABLE 6

| Property (units) | Standard | Polyol HF1 |
|---|---|---|
| Hydroxyl number (mg KOH/g) | ASTM E1899 | 158.15 |

| | |
|---|---|
| Viscosity (η@25° C., Pa · s) | 2.6 |

### Example 8. Preparation of Methylated, Hydroformylated, and Hydrogenated Fatty Acids from Algal Oil

Fatty acids and methyl esters derived from triglyceride oils can be hydroformylated. In this example, methylated and hydroformylated fatty acids were prepared in two steps. The synthesis involves the methylation of an algal oil (containing 91% oleate, 5% linoleate, 1.8% palmitate, and 1.12% others; with an Iodine Value (IV) of 88 g I₂/100 g) to produce fatty acid methyl esters, which is followed by hydroformylation and hydrogenation of the methyl esters to form polyols. AO, algae oil; M-AO, methylated algae oil; HF-H-M-AO, methylated and hydroformylated fatty acids. Generation of fatty acid methyl esters of algal oil was carried out as follows. Algal oil (100 g, ca. 0.115 mol assuming triolein), methanol (165 g, ca. 5.16 mol, ca. 45-fold molar excess to oil), and potassium methoxide (1 g, 1% wt/wt to oil) were combined into 500-mL flask equipped with a condenser. The mixture was stirred vigorously under reflux conditions (70° C.) for 3 hrs. The mixture was then cooled to around 50° C. and Amberlite IR120 H resin was added to neutralize the reaction. The mixture was then stirred at 50° C. for 1 hr. The Amberlite IR120 H resin was filtered out and the solvent was removed via rotary evaporation. Glycerol was removed by a separatory funnel, and then washed with 10 mL of water. Residual solvent and water in the organic phase were removed by rotary evaporation under high vacuum at 70° C. for 2 hrs.

Hydroformylation of the resulting fatty acid methyl esters was carried out as follows. A 500-mL reactor was charged with methylated algae oil (100 g) and catalyst (0.1 g of Rh(CO)₂acac and 0.55 g TPP). The reactor was flushed 4×100 psig with syngas, heated to 90° C. and the syngas pressure was maintained at 1,000 psi for 6 hrs. After cooling the reactor to room temperature and releasing the syngas, the reactor was opened, 50 g isopropanol and 10 g Raney nickel were added. The mixture was then flushed 4×100 psig with hydrogen and heated to 110° C. at 1,000 psi for 5 hrs. The reactor was then cooled to room temperature and opened. The mixture was diluted with another 100 mL of isopropanol and filtered through Celite® to remove the Ni and Rh catalysts. Residual solvent was removed by rotary evaporation under low pressure at 60° C., followed by high vacuum at 70° C. for 2 hrs. The resulting polyol was characterized by hydroxyl number, FT-IR, and GPC. Hydroxyl number was assessed by ASTM method E1899 and determined to be 158 mg KOH/g, which was about a 90% conversion rate of fatty acid methyl esters to polyol.

FT-IR analysis of algal oil and fatty acid methyl esters derived therefrom both show peaks indicative of C═C bonds at 3005 cm⁻¹ and 1640 cm⁻¹, but which disappeared after hydroformylation. A strong, broad OH peak was observed at 3300 cm⁻¹ in the hydroformylated, hydrogenated fatty acid methyl esters.

### Example 9. Synthesis of Polyester Diols from Hydroformylated, Hydrogenated Methyl Esters of Algal Oil

Hydroformylated, hydrogenated methyl esters of algal oil (HFMEOA) prepared as in EXAMPLE 8 along with 1,6-hexanediol (1,6-HD) was used as soft segments in polyurethane (PU) elastomeric materials. A polyester diol was prepared by polyesterification of HFMEOA using 1,6-HD as an initiator and 0.14% DBTDL as catalyst.

The ratio of HFMEOA and 1,6-HD for making soft segments for PU elastomers largely depends on the desired molecular weight of the diol being developed. In this example, diol molecular weights of 1,000 and 2,000 were synthesized to serve as soft segments in elastomeric PUs. As an example, raw material content for MW=2000 was calculated using the following equation. The equation can be used to determine the number of moles of HFMEOA required to react with one mole of 1,6-HD to obtain the desired molecular weight of the soft segment. M_{polyol}, desired molecular weight of polyester; M_{1,6HD}, molecular weight of 1,6 hexanediol (118.1 g/mol); M_{HFMEOA}, molecular weight of HFMEOA (328.3 g/mol); M_{CH3OH}, molecular weight of methanol (32 g/mol); and n, number of moles of HFMEOA (or methanol) needed to obtain the desired M_{polyol}. M_{polyol}=M_{1,6HD}+n(M_{HFMEOA}−M_{CH3OH})

For a desired polyol with a MW of 2000, moles of HFMEOA required were calculated as follows 2000=118.1+n(328.3−32). n=6.351 mol of HFMEOA required, resulting in the equivalent number of moles of methanol produced in the reaction. Thus, for each mol of 1,6-HD, 2085 g of HFMEOA were consumed and 203.2 g of methanol were produced. For a desired polyol with a MW of 1,000, the moles of HFMEOA required were calculated as follows: 1,000=118.1+n(328.3−32). n=2.976 mol of HFMEOA required, resulting in the equivalent number of moles of methanol produced in the reaction. Thus, for each mol of 1,6-HD, 977 g of HFMEOA were consumed and 95.2 g of methanol were produced.

Based on the calculations above, two formulations of polyester polyol (MW of 2,000 and 1,000) were prepared according to the amounts of reagents listed in TABLE 7. For both syntheses, a Dean-Stark Trap polyesterification reactor was charged with HFMEOA, 1,6-HD, and DBTDL. The reactor was heated initially to 160° C. with nitrogen sparge. Through the continuous removal of methanol, the equilibrium of polyesterification was shifted to the formation of polyester polyol. The temperature was then increased in a step-wise fashion as follows: 160° C. for 1 hr, increasing to 180° C. for 3 hrs, increasing to 200° C. for 3 hrs, and finally increasing to 210° C. for 3 hrs. Characteristics of the resulting polyols are shown in TABLE 8.

TABLE 7

| Reagent (grams) | Polyol HF2 (M = 2000) | Polyol HF3 (M = 1000) |
|---|---|---|
| HFMEOA | 52.12 | 44.00 |
| 1,6-HD | 2.95 | 5.5 |
| DBTDL catalyst | 0.08 | 0.07 |

TABLE 8

| | Polyol HF2 | Polyol HF3 |
|---|---|---|
| Property | (M = 2000) | (M = 1000) |
| Hydroxyl number (mg KOH/g) | 44.2 | 88.2 |
| Viscosity @ 25° C., Pa · s) | 7.79 | 2.60 |
| Acid value (mg KOH/g) | 0.2 | 0.32 |
| MW (g/mol) | 2540 | 1270 |

### Example 10. Synthesis of a Polyester Diol from Fatty Acid Methyl Esters and 1,4-Butanediol

This example describes the generation of a polyester diol (designated Et-Me-EAO-BD) prepared from a 2:1 molar ratio of epoxidized, ring opened methyl esters of an algal oil and 1,4-butanediol.

Algal triglyceride oil, characterized by an Iodine Value of 88 g I₂/100 g and a fatty acid profile of 91% oleate, 5% linoleate, 1.8% palmitate, and 1.12% other fatty acids, was reacted with methanol (HPLC grade, Fisher Scientific) in the presence of KOCH₃ to generate FAMEs. Algal FAMEs were then transesterified with 1,4-butanediol in the presence of toluene with KOCH₃ as a catalyst using the amounts and reagents according to TABLE 9 to produce a diol (denoted Me-AO-BD) characterized by an IV of 81.13 g I₂/100 g.

Epoxidation of Me-AO-BD was carried out using the amounts and reagents according to TABLE 10 to prepare a diol designated EMe-AO-BD. Me-AO-BD, acetic acid, Amberlite, and toluene were charged in a reactor equipped with a magnetic bar stirrer, thermometer, and neck for addition of chemicals. The mixture was heated to 65° C. H₂O₂ then was added dropwise. The reaction was continued at 70° C. for 7 hrs. Amberlite was then removed by filtration, then the mixture was washed with hot distilled water until a neutral pH was reached. Washing was carried out in a separatory funnel. The mixture was shaken then allowed to settle and separate. The water (bottom) layer was removed and the organic layer was dried under vacuum (rotary evaporator). Solvent and water were removed by vacuum distillation.

Ring opening of epoxidized diol EMe-AO-BD to create the diol Et-EMe-AO-BD was achieved using the amounts and reagents according to TABLE 11. Properties of Et-EMe-AO-BD are shown in TABLE 12. Ethanol and HBF₄ catalyst were added to a 250-mL, three-neck round bottom flask, equipped with a reflux condenser and a strong mechanical stirrer. The mixture was heated to the boiling point of ethanol. EMe-AO-BD was added dropwise over 5 min from a dropping funnel. The reaction mixture was stirred for 25 min. Next, about 3 g of Lewatitte MP-64 ion-exchange resin (Bayer), a neutralizing agent for the catalyst, was added. The mixture was stirred and left to cool for about 1 hr. The ion-exchange resin was separated from the liquid part by filtration. Ethanol was removed by evaporation (distillation and rotary evaporation), first at low vacuum and then for 1 hr with high vacuum at temperature 70-80° C.

TABLE 9

| Reagent | Amount | units |
|---|---|---|
| FAMEs prepared from Algal Oil | 50 | g |
| 1,4-butanediol | 7.6 | g |
| KOCH₃ (90%, Alfa Aesar) | 0.8 | g |
| Toluene | 40 | mL |

TABLE 10

| Reagent | Amount | units |
|---|---|---|
| Me-AO-BD-1 | 37 | g |
| AcOH | 3.5 | g |
| H₂O₂ | 20.1 | g |
| Amberlite IR 120H (Aldrich) | 5.9 | g |
| Toluene (≥99.3%) | 18.5 | g |

TABLE 11

| Reagent | Amount | units |
|---|---|---|
| EMe-AO-BD | 30 | g |
| EtOH (200 proof, 99.5%, A.C.S reagent, Aldrich) | 25.2 | g |
| HBF₄ (Aldrich) | 0.11 | g |
| Lewatite MP 64 (Bayer) | 3 | g |

TABLE 12

| | | Polyol |
|---|---|---|
| Property (units) | Standard | Et-EMe-AO-BD |
| Molecular Weight (g/mol) | | 763 |
| Epoxy oxygen content (%) | ASTM D1652, | 0.03 |
| | Test method B | |
| Hydroxyl number (mg KOH/g) | ASTM D4274-05 D | 147 |

| | |
|---|---|
| Viscosity (η @ 25° C., Pa · s) | 0.43 |

### Example 11. Synthesis of a Polyester Diol from an Algal Polyol and 1,4-Butanediol

This example describes the generation of a polyester diol (designated Me-Et-EAO-BD), prepared from a 2:1 molar ratio of hydroxy methyl esters of an algal polyol and 1,4-butanediol.

Algal triglyceride oil characterized by an Iodine Value of 88 g/100 g and a fatty acid profile of 91% oleate, 5% linoleate, 1.8% palmitate, and 1.12% other fatty acids was epoxidized and ring opened with ethanol according to the procedure described in EXAMPLE 1 to generate a polyol designated Et-EAO. Hydroxy methyl esters of Et-EAO, designated Me-Et-EAO, were obtained via methanolysis by reacting Et-EAO with methanol in the presence of KOCH₃. Me-Et-EAO was characterized by a viscosity of 0.43 Pa·s and a hydroxyl number of 155 mg KOH/g.

A polyester diol, Me-Et-EAO-BD, was prepared by transesterification of Me-Et-EAO and 1,4-butanediol using KOCH₃ as a catalyst. Properties of Me-Et-EAO-BD are listed in TABLE 13.

TABLE 13

| | | Polyol Me- |
|---|---|---|
| Property (units) | Standard | Et-EAO-BD |
| Molecular Weight (g/mol) | | 801 |
| Hydroxyl number (mg KOH/g) | ASTM D4274-05 D | 140 |
| Viscosity (η @ 25° C., Pa · s | | 0.66 |

### Example 12. Characterization of Polyester Diols from Algal Oil Polyols

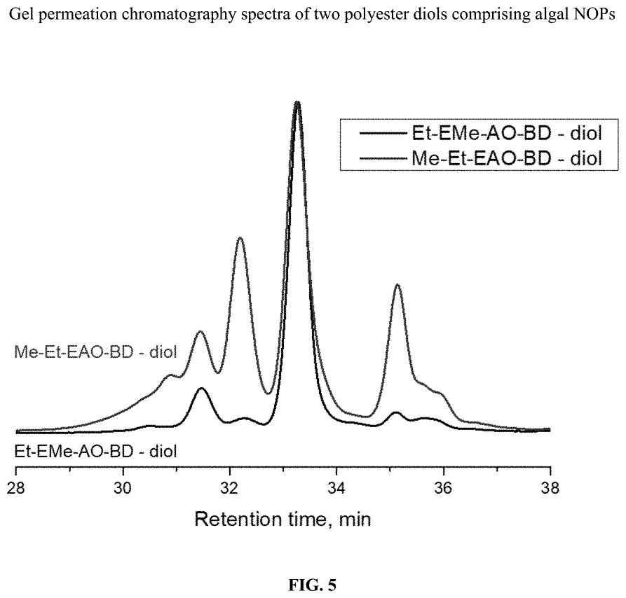

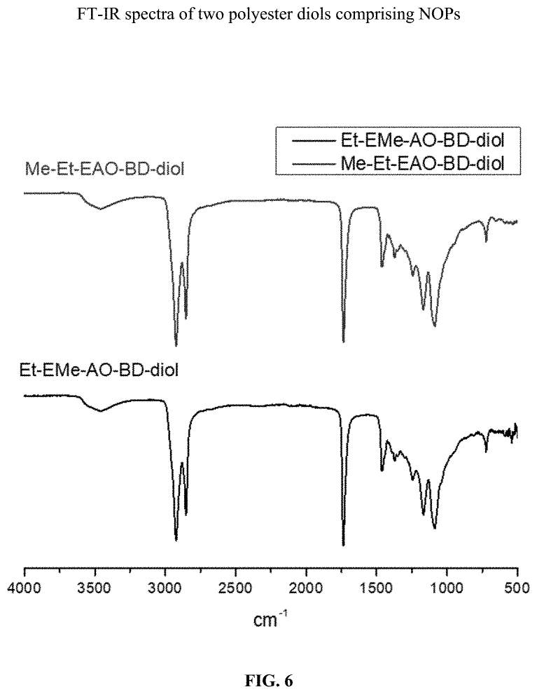

This example describes evaluation of polyester diols Et-EMe-AO-BD and Me-Et-EAO-BD generated in EXAMPLE 10 and 11. Both diols were washed with distilled water several times to remove the catalyst, then assessed by gel permeation chromatography (GPC) and Fourier-transform infrared (FT-IR) spectroscopy. FIG. 5 presents GPC traces of the two diols, showing similar retention time of the predominant species. Et-EMe-AO-BD is characterized by a narrower molecular weight distribution than that of Me-Et-EAO-BD. FIG. 6 presents FT-IR spectra of the two diols. A broad absorbance was observed at 3454 cm⁻¹, indicating that the OH groups were introduced.

### Example 13. Synthesis of Polyester Diols from an Algal Polyol and 1,6-Hexanediol

This example describes the generation of polyester diols with molecular weight of ca. 1,000, 1,500, and 2,000 prepared from methyl esters of ethanol ring opened epoxidized algal oil and 1,6-hexanediol.

Algal triglyceride oil characterized by an Iodine Value of 88 g I₂/100 g and a fatty acid profile of 91% oleate, 5% linoleate, 1.8% palmitate, and 1.12% other fatty acids was epoxidized and ring opened with ethanol according to the procedure described in EXAMPLE 1 to generate a polyol designated Et-EAO. Methyl esters of Et-EAO, designated Me-Et-EAO, were obtained via methanolysis by reacting Et-EAO with methanol in the presence of KOCH₃. Me-Et-EAO was characterized by a viscosity of 0.43 Pa·s and a hydroxyl number of 155 mg KOH/g.

Polyester diols of differing molecular weights, designated Me-Et-EAO-HD1000, Me-Et-EAO-HD1500, and Me-Et-EAO-HD2000, were generated from Me-Et-EAO and 1,6-hexanediol using TIP as a catalyst. Molar ratios of Me-Et-EAO to 1,6-hexanediol were kept at 3:1, 5:1, and 6:1, while catalyst concentration was kept at 0.5 wt. % for each reaction. Starting materials, including catalyst, were charged into a 3-necked, round bottom flask equipped with magnetic stirrer, nitrogen inlet, thermocouple, Dean Stark, condenser, and sparger. Nitrogen was sparged for 15 min at which point the vessel was heated to 160° C. for 15 min. The temperature was further ramped to 200° C. over the course of 1 hr, then held for 34-64 hrs depending upon the molecular weight desired. Heating was stopped when the content of Me-Et-EAO was less than 2% of the reaction products as assessed by gel permeation chromatography. TABLE 14 lists properties of these three polyester diols.

TABLE 14

| | Me-Et-EAO- | Me-Et-EAO- | Me-Et-EAO- |
|---|---|---|---|
| Property | HD1000 | HD1500 | HD2000 |
| Hydroxyl number | 97.6 | 70 | 56.7 |
| (mg KOH/g) | | | |
| Viscosity @ | 1.4 | 2.1 | 4.7 |
| 25° C., Pa · s | | | |
| MW (g/mol) | 1150 | 1600 | 1980 |

### Example 14: Anionic Waterborne Polyurethane Dispersion Prepared with a Natural Oil Polyol

This example describes the generation of anionic waterborne dispersions prepared with prepolymers derived from bio-based or petroleum-based feedstocks. A polyester diol, (designated PDO-2178) was prepared from an algal polyol according to process outlined in EXAMPLE 13. PDO-2178 was characterized by a hydroxyl number of 51.5 mg KOH/g and a molecular weight of 2178 g/mol.

TABLE 15 lists components of isocyanate-terminated prepolymers and amounts thereof. TABLE 16 lists components of anionic waterborne PUDs. Reagents in the ratios listed in TABLE 15 and TABLE 16 were combined as follows. Poly(propylene oxide) (PPO) under the trade name Acclaim 2200 was obtained from Covestro, USA. Acclaim 2200 is a 2000 molecular weight diol. Isocyanate-terminated prepolymers designated AP1-AP3 were prepared by adding the indicated diol, dimethylolpropionic acid, and N-methyl-2-pyrrolidone into a round bottom flask equipped with a temperature monitoring device, agitator, water-cooled condenser, and inert gas sparge. The flask was agitated and heated to 85-90° C. IPDI was then added. The reaction was allowed to proceed for 3-4 hrs. Waterborne dispersions AWPUD1-AWPUD3 were prepared by charging a 4-oz glass jar with the prepolymer according to TABLE 16. A mechanical stirrer was applied to the prepolymer, then triethylamine and water were added sequentially. Ethylene diamine dissolved in deionized water according to the ratios in TABLE 16 was then added slowly with constant stirring.

TABLE 15

| Reagent (grams) | AP1 | AP2 | AP3 |
|---|---|---|---|
| Poly glycol P2000 | 25.92 | 0 | 0 |
| Acclaim 2200 | 0 | 25.92 | 0 |
| PDO-2178 | 0 | 0 | 28.2 |
| Dimethylolpropionic acid (DMPA) | 2.12 | 2.12 | 2.12 |
| N-methyl-2-pyrrolidone (NMP) | 9.7 | 9.7 | 9.7 |
| Isophorone diisocyanate (IPDI) | 9.58 | 9.58 | 9.58 |

TABLE 16

| Reagent (grams) | AWPUD1 | AWPUD2 | AWPUD3 |
|---|---|---|---|
| Prepolymer | AP1 | AP2 | AP3 |
| Triethylamine (TEA) | 1.358 | 1.358 | 1.358 |
| Distilled Water | 39.1 | 39.1 | 39.1 |
| Ethylene diamine (EDA) | 0.432 | 0.432 | 0.432 |
| Distilled Water | 10.8 | 10.8 | 10.8 |

### Example 15: Preparation of a Waterborne Polyurethane Dispersion Prepared with Algal Oil Polyol and Characterization Thereof

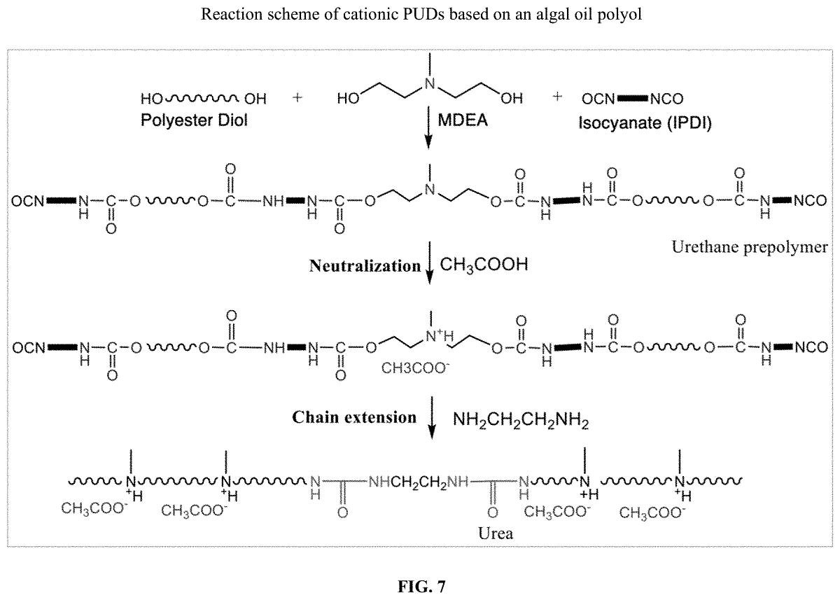

This example describes the preparation and characterization of a cationic waterborne PUD from an algal oil derived polyol. An overview of the steps of the reactions are shown in FIG. 7. TABLE 17 lists reagents used to generate isocyanate-terminated prepolymer CP7. TABLE 18 lists components of cationic waterborne PUD CWPUD7. Reagents in the amounts listed in TABLE 17 and TABLE 18 were combined as follows. Isocyanate-terminated prepolymer CP7 was prepared by adding the polyester diol Me-Et-EAO-HD1500 of EXAMPLE 13 and IPDI to a 1-L three-neck round bottom flask equipped with mechanical stirrer, reflux condenser and nitrogen supply. The reaction mixture was stirred and heated to 80° C. After 150 min, N-methyldiethanolamine (MDEA) was added and heating continued for 15 min. Methyl ethyl ketone (MEK) was then added periodically (50 mL in total) to reduce the viscosity of the reaction. After 2 hrs, the reaction was cooled to room temperature and another 25 mL of MEK was added along with acetic acid (glacial, >99.8%) as a neutralizer under stirring for 30 min. After neutralization with acetic acid, distilled water was added for emulsification and finally, ethylenediamine (EDA, 99%, extra pure) solution in water was added to the reaction mixture which was stirred vigorously for 2 hrs. MEK was removed by vacuum distillation at low vacuum at 60° C. for 30 min to obtain CWPUD7. The ratio of soft to hard segments in CWPUD7 was 70:30.

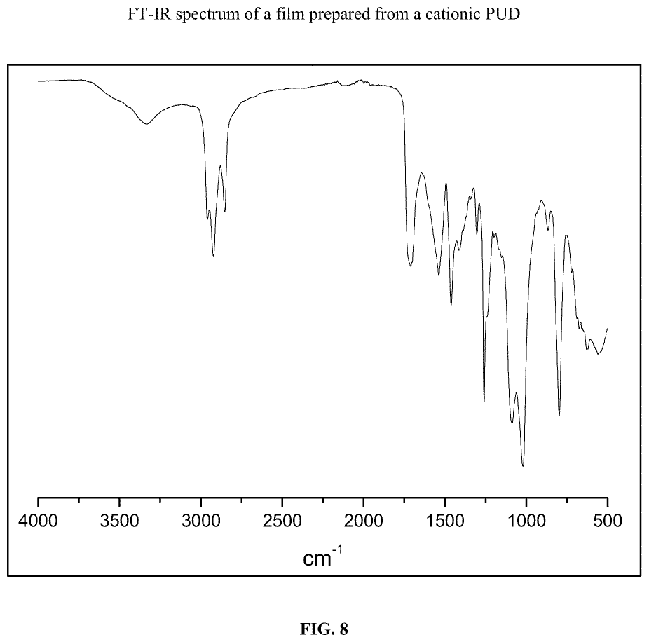

TABLE 19 lists properties of CWPUD7. Stability of the PUD was evaluated by centrifuging CWPUD7 at 3,000 rpm for 30 min. No separation occurred. A polyurethane film was made by drying CWPUD7 in an aluminum pan for 3 days at room temperature followed by drying at 3 days at 50° C. FT-IR spectra of this film is shown in FIG. 8. The absence of a characteristic band at 2270 cm⁻¹ indicates that all of the isocyanate groups reacted in this system.

TABLE 17

| | |
|---|---|
| Me-Et-EAO-HD1500 diol (g) | 80 |
| Isophorone diisocyanate, Arcos Organic (g) | 36.7 |
| N-methyl diethanolamine, ≥99%, Sigma (g) | 11.9 |
| Methylethyl ketone, Fisher (mL) | 75 |

TABLE 18

| | |
|---|---|
| Prepolymer | CP7 |
| Acetic Acid (≥99.8%, Fisher) | 6 g |
| Ethylene diamine | 0.9 g |
| Distilled Water | 366 mL |

TABLE 19

| | |
|---|---|
| Viscosity @ 25° C. (Pa · s) | 8.6 |
| pH | 5-6 |
| Solids Content (%) | 26 |
| Distilled Water | 366 mL |

### Example 16: Preparation of Waterborne Polyurethane Dispersions Prepared with Algal Polyols and Characterization Thereof

Cationic PUDs were prepared from polyester diols prepared from methyl esters of ethanol ring opened epoxidized algal oil and 1,6-hexanediol.

Polyester diols of differing molecular weights were generated from Me-Et-EAO and 1,6-hexanediol as described in EXAMPLE 13, using catalyst TIP at 0.5%. TABLE 20 presents properties of these diols. Isocyanate-terminated prepolymers were synthesized according the process described in EXAMPLE 15 and using the reagents and molar ratios provided in TABLE 21. Cationic waterborne PUDs were then generated from these prepolymers according to the process outlined in EXAMPLE 15, using the solvent indicated in TABLE 21. TABLE 22 lists properties of these cationic PUDs. The stability of each product was evaluated by centrifuging the dispersions at 3,000 rpm for 30 min. No separation occurred. Polyurethane films were made by drying the dispersions separately in aluminum pans for 3 days at room temperature followed by drying at 3 days at 50° C. TABLE 23 presents properties of films prepared from these dispersions.

TABLE 20

| | Me-Et- | Me-Et- | Me-Et- | Me-Et- |
|---|---|---|---|---|
| | EAO- | EAO- | EAO- | EAO- |
| Property | HD800 | HD1200 | HD1500 | HD1600 |
| Molar Ratio [Me-Et-EAO]:[HDO] | 2:1 | 3:1 | 5:1 | 5:1 |
| Hydroxyl number (mg KOH/g) | 140 | 93 | 74 | 70 |
| MW (g/mol) | 802 | 1207 | 1516 | 1603 |
| Viscosity @ 25° C. (Pa · s) | 1.7 | 1.4 | 1.7 | 2.1 |

TABLE 21

| | | | Molar Ratio | | | |
|---|---|---|---|---|---|---|
| Dispersion | Polyester Diol | Solvent | Diol | MDEA | EDA | IPDI |
| CWPUD1600 | Me-Et-EAO-HD1600 | MEK | 1 | 2 | 0.3 | 3.3 |
| CWPUD1500 | Me-Et-EAO-HD1500 | NMP | 1 | 2 | 0.3 | 3.3 |
| CWPUD1200 | Me-Et-EAO-HD1200 | MEK | 1 | 2 | 0.3 | 3.3 |
| CWPUD800 | Me-Et-EAO-HD800 | MEK | 1.25 | 1.75 | 0.3 | 3.3 |

TABLE 22

| | | | Viscosity @ | |
|---|---|---|---|---|
| Dispersion | HS (wt %) | Solids Content (%) | 25° C. (Pa · s) | pH |
| CWPUD1600 | 30 | 26.8 | 8.6 | 5-6 |
| CWPUD1500 | 31 | 25.7 | 26.8 | 5-6 |
| CWPUD1200 | 35.3 | 27.6 | 29.9 | 5-6 |
| CWPUD800 | 34.8 | 26.6 | 16.3 | 5-6 |

TABLE 23

| | T_{g}, | Tensile strength, | Elongation | Contact angle |
|---|---|---|---|---|
| Dispersion | ° C. | at break, MPa | at break, % | (θ_{w}), deg |
| CWPUD1600 | −15 | 0.3 | >1025 | 94.4 ± 4.6 |
| CWPUD1500 | −31 | 1.26 | 703 | 92.4 ± 3.4 |
| CWPUD1200 | 8 | 2.36 | 686 | 80.8 ± 9.2 |
| CWPUD800 | 14 | 6.94 | 455 | 75.7 ± 4.1 |

### Example 17: Cationic Waterborne Polyurethane Dispersions Based on Algae Oil Polyols Applied to Textiles

For each of the cationic waterborne PUDs of EXAMPLE 16, a bath was prepared by diluting each PUD 10-fold to approximately 2-3% solids in water. Swatches of different fabric types including cotton, polyester, and polyamide Lycra® were individually immersed in the PUD bath. Excess fluid was removed using a roller system. The resulting deposition left behind 3-4% solids (wt polymer/wt fabric). Fabric was dried in a stenter machine, ramping temperature from 80° C. to 150° C. After drying, various properties of the coated fabric swatches were assessed, including water repellency, abrasion resistance, and tear strength.

### Example 18: Waterborne Polyurethane Dispersions with Increased Solids Content and Characterization Thereof

Polyol 2 from EXAMPLE 1 was used to prepare five separate, identical PUD formulations termed WPU-AOP-S1 through WPU-AOP-S1-5. Polyol, IPDI, MDEA, and catalyst (DBTDL) were charged in a 2-L three-neck round bottom flask equipped with mechanical stirrer, reflux condenser, and nitrogen supply in the molar proportions illustrated in TABLE 24. The reaction mixture was stirred at 1,000 rpm at 80° C. for 2 hours and 30 minutes. Solvent (MEK) was added in intervals to reduce viscosity. Due to the high viscosity of the reaction mixture, the last portion of solvent was added after the reaction mixture was cooled to room temperature, followed by the addition of acetic acid as neutralizer under stirring for 30 minutes. After neutralization with acetic acid, distilled water was added for emulsification. The reaction was then vigorously stirred for an additional 2 hours. MEK was evaporated at 45° C. for 2 hours at low vacuum.

Hard segment content (HS) of each PUD was calculated as follows: (MW of MDEA×moles of MDEA)+(MW of acetic acid×moles of acetic acid).

TABLE 24

| | | | Mols | | | | |
|---|---|---|---|---|---|---|---|
| | | | AOP | MDEA | IPDI | MDEA, | HS, |
| PUD Formulation | Solvent | Mixing rate, rpm | OH | OH | NCO | wt % | wt % |
| WPU-AOP-S1 | MEK | 1,000 (2 h) | 1 | 0.95 | 2 | 9.0 | 44.2 |
| WPU-AOP-S1-2 | MEK | 1,000 (2 h) | 1 | 0.95 | 2 | 9.0 | 44.2 |
| WPU-AOP-S1-3 | MEK | 1,000 (2 h) | 1 | 0.95 | 2 | 9.0 | 44.2 |
| WPU-AOP-S1-4 | MEK | 1,000 (2 h) | 1 | 0.95 | 2 | 9.0 | 44.2 |
| WPU-AOP-S1-5 | MEK | 1,000 (2 h) | 1 | 0.95 | 2 | 9.0 | 44.2 |

Particle size distribution, PDI, water contact angle, water absorption, solids content, viscosity, glass transition temperature, tensile strength, and break at elongation of the resulting PUDs or films thereof were measured using the method described as follows.

Solids content. Solids content is the mass of the material remaining after drying at 70° C. for about 2 hr. Solids content was calculated as follows: (dry mass of the PUD/starting mass of the PUD)×100.

Viscosity. Viscosity was determined at about 25° C. using a TA Instruments AR 2000 rheometer with a 40 mm 2-degree steel cone.

Pad dry technique. Textile finishes can be applied by a Pad-Dry technique described as follows. The textile is drawn through a bath containing the PUD and then through a set of rollers (a mangle) to remove excess dispersion. After wet processing, the textile is dried using a Stenter (or a Tenter), an oven used for drying and heat treating (curing) fabric finishes. The residence time and temperature of the textile in the Stenter can be precisely controlled to effect drying of the finish to the textile and allow for reactions with additives to occur. For example, chemically blocked isocyanates can be added during drying to further react with the textile and the PUD finish.

Particle size distribution. The particle size distribution and PDI of the PUDs were measured on a Zetasizer (Malvern instruments Nano-ZS90). Approximately 10 μL of the PUD was diluted with 990 μL distilled water before testing.

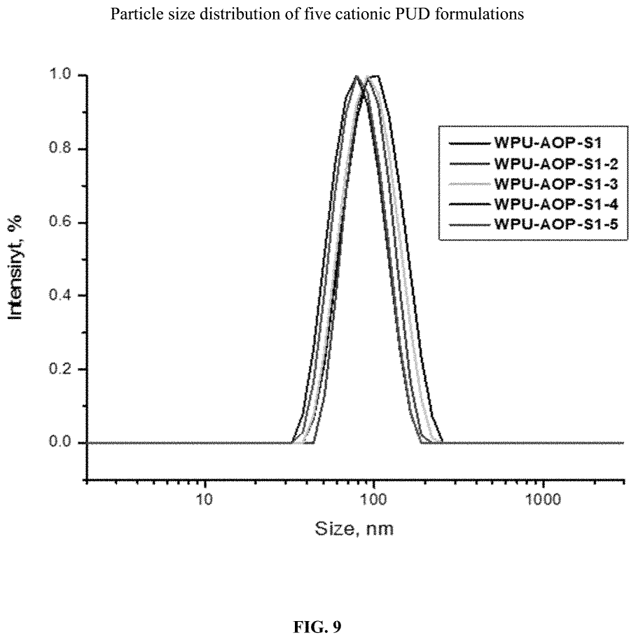

FIG. 9 shows the particle size distribution of the five PUD formulations. The measured values are listed in TABLE 25.

TABLE 25

| | Bio-based | | | | | | | Particle |
|---|---|---|---|---|---|---|---|---|
| PUD | content in | MDEA, | Solids | Viscosity, | | | | size, nm |
| Formulation | polymer, % | wt % | content, % | mPa · s | pH | Appearance | Stability^{a} | (PDI) |
| WPU-AOP-S1 | 53.5 | 9.0 | 26.2 | 6.1 | 5 | Translucent | NS | 92 |
| | | | | | | white | | (0.110) |
| WPU-AOP-S1-2 | 53.5 | 9.0 | 24.5 | 4.4 | 5 | Translucent | NS | 89 |
| | | | | | | white | | (0.053) |
| WPU-AOP-S1-3 | 53.5 | 9.0 | 24.1 | 4.6 | 5 | Translucent | NS | 86 |
| | | | | | | white | | (0.121) |
| WPU-AOP-S1-4 | 53.5 | 9.0 | 24.1 | 4.7 | 5 | Translucent | NS | 74 |
| | | | | | | white | | (0.100) |
| WPU-AOP-S1-5 | 53.5 | 9.0 | 23.8 | 4.8 | 5 | Translucent | NS | 77 |
| | | | | | | white | | (0.081) |

^{a}No sedimentation, NS; little sedimentation, LS.

Water contact angle measurements. Microscope glass slides (2.5×5 cm²) were immersed into the PUDs and then placed horizontally on an aluminum weighing dish such that the corners of the slide were supported by the sides of the dish. Subsequently, PUD films were dried for 1 hr at room temperature, 1 hr in an oven at 50° C. and 1 hr at 120° C. prior to water contact angle measurements. Contact angle measurements were performed with a Drop Shape Analyzer DSA25. Water contact angles were the average of 10 measurements. The measured values are listed in TABLE 26.

Water absorption. The water absorption of WPU films was determined gravimetrically. Round-shaped film samples (1 cm diameter) were dried at 70° C. for 2 h before testing. The PUD films of known weight (m₀) were immersed in distilled water at room temperature for 24 h. Samples were then wiped with paper towel to remove excess water and weighed again (m₁). An average value of five measurements was used for each sample. The percentage of water absorption (WA) was calculated as follows: WA=((m₁−m₀)/m₀)×100. The measured values are listed in TABLE 26.

TABLE 26

| | | | | | Contact | Water |
|---|---|---|---|---|---|---|
| | GPC analysis | | | | angle (θ_{w}), | absorption, |
| PUD Formulation | Mₙ | M_{w} | Mₚₑₐₖ | M_{w}/Mₙ | deg | % |

| | | | |
|---|---|---|---|
| WPU-AOP-S1 | Insoluble in THF | 90 ± 4.6 | 3.5 |
| WPU-AOP-S1-2 | Insoluble in THF | 93 ± 3.8 | 3.6 |
| WPU-AOP-S1-3 | Insoluble in THF | 93 ± 4.2 | 3.5 |
| WPU-AOP-S1-4 | Insoluble in THF | 93 ± 4.5 | 3.3 |
| WPU-AOP-S1-5 | Insoluble in THF | 95 ± 2.3 | 3.2 |

Preparation of PUD Films for DSC and mechanical properties. Preparation of films for the determination of water absorption, tensile strength, and elongation at break measurements were carried out by casting dispersions in Teflon molds and curing for 48 hours at room temperature followed by 48 hours at 70° C. Samples for differential scanning calorimetry (DSC) were cut from polymer films (weight of about 10-12 mg). DSC was carried out on a thermal analyzer (TA Instruments, DSC Q100) in a nitrogen atmosphere (flow rate 50 ml/min). Samples were cooled to −80° C., then heated to 120° C. with a heating rate of 10° C./min to erase the thermal history of the sample. Samples were cooled to −80° C. with a cooling rate of 10° C./min, and heated again to 120° C. with heating rate of 10° C./min. The glass transition temperature (T_{g}) was determined from the second run as the midpoint temperature in heat capacity change.

The mechanical properties of the films were analyzed by using an Instron Universal Testing Machine (model 3367) with crosshead speed of 50 mm/min. Rectangular samples of 60×8 mm² (length×width) were used. An average value of five replicates of each sample was taken. The measured values are listed in TABLE 27.

TABLE 27

| | T_{g}^{DSC}, | Tensile strength, | Elongation |
|---|---|---|---|
| PUD Formulation | ° C. | MPa | at break, % |
| WPU-AOP-S1 | +14 | 15.5 | 285 |
| WPU-AOP-S1-2 | +14 | 12.4 | 292 |
| WPU-AOP-S1-3 | +12 | 14.0 | 271 |
| WPU-AOP-S1-4 | +13 | 10.3 | 247 |
| WPU-AOP-S1-5 | +13 | 13.1 | 299 |

### Example 19: Preparation of Cationic Polyurethane Dispersions Based on Algal Oil Polyols

Polyol 2 from EXAMPLE 1 was used to prepare two PUD formulations termed WPU-AOP-S2 and WPU-AOP-S2-2. Polyol, IPDI, MDEA, and catalyst (DBTDL) were charged in a 2-L three-neck round bottom flask equipped with mechanical stirrer, reflux condenser, and nitrogen supply in the molar proportions illustrated in TABLE 28. Compared to the PUDs from EXAMPLE 18, these PUD formulations contained slightly less MDEA, resulting in a lower hard segment content and lower water absorption.

In the case of WPU-AOP-S2-2, the reaction mixture was stirred at 1,000 rpm at 80° C. for 2 hours and 30 minutes. Solvent (MEK) was added in intervals to reduce viscosity. Due to the high viscosity of the reaction mixture, the last portion of solvent was added after the reaction mixture was cooled to room temperature, followed by the addition of acetic acid as neutralizer under stirring for 30 minutes. After neutralization with acetic acid, distilled water was added for emulsification. The reaction was then vigorously stirred for an additional 2 hours. MEK was evaporated at 45° C. for 2 hours at low vacuum.

In the case of WPU-AOP-S2, the reaction mixture was stirred at 1,000 rpm at 80-85° C. for 2 hours. MEK solvent was added in intervals to reduce viscosity. Due to the high viscosity of the reaction mixture, the last portion of solvent was added after the reaction mixture was cooled to room temperature, followed by the addition of acetic acid as neutralizer under stirring for 30 minutes. After neutralization with acetic acid, distilled water was added for emulsification. The reaction was then vigorously stirred for 5 minutes with D-500 homogenizer (Scilogix) at 10,000 rpm. MEK was evaporated at 45° C. for 2 hours at low vacuum.

TABLE 28

| | | | | Mols | | | | |
|---|---|---|---|---|---|---|---|---|
| | | Mixing | | AOP | MDEA | IPDI | MDEA, | HS, |
| PUD Formulation | Solvent | rate, rpm | | OH | OH | NCO | wt % | wt % |
| WPU-AOP-S2 | MEK | 10,000 | (5 min) | 1 | 0.90 | 1.95 | 8.6 | 43.2 |
| WPU-AOP-S2-2 | MEK | 1,000 | (2 h) | 1 | 0.90 | 1.95 | 8.6 | 43.2 |

Particle size distribution, polydispersity index, water contact angle and absorption, solids content, viscosity, glass transition temperature, tensile strength, and break at elongation of the resulting PUDs and films thereof were measured using the methods described as in EXAMPLE 18.

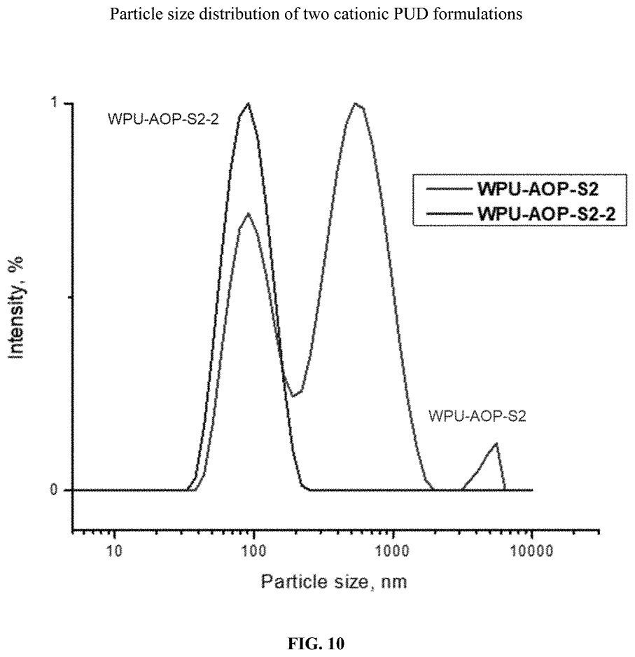

FIG. 10 shows the particle size distribution of the two PUD formulations. The measured values are listed in TABLE 29. The water contact angle and water absorption values are listed in TABLE 30. The T_{g}, tensile strength, and elongation at break measurements are listed in TABLE 31.

TABLE 29

| | Bio-based | | | | | | | |
|---|---|---|---|---|---|---|---|---|
| | content in | | Solid | | | | | Particle |
| | polymer, | MDEA, | content, | Viscosity, | | | | size, nm |
| PUD Formulation | % | wt % | % | mPa · s | pH | Appearance | Stability^{a} | (PDI) |
| WPU-AOP-S2 | 54.4 | 8.6 | 24.3 | 7.2 | 5 | Milky white | LS | 223 |
| | | | | | | | | (0.473) |
| WPU-AOP-S2-2 | 54.4 | 8.6 | 24.0 | 4.9 | 5 | Translucent | NS | 84 |
| | | | | | | white | | (0.103) |

^{a}No sedimentation, NS; little sedimentation, LS.

TABLE 30

| | GPC analysis | | | | Contact angle | Water |
|---|---|---|---|---|---|---|
| PUD Formulation | Mₙ | M_{w} | Mₚₑₐₖ | M_{w}/Mₙ | (θ_{w}), deg | absorption, % |

| | | | |
|---|---|---|---|
| WPU-AOP-S2 | Insoluble in THF | 93 ± 3.3 | 2.1 |
| WPU-AOP-S2-2 | Insoluble in THF | 98 ± 5.7 | 2.5 |

TABLE 31

| | Hard | T_{g}^{DSC}, | Tensile | Elongation at |
|---|---|---|---|---|
| PUD Formulation | segments, % | ° C. | strength, MPa | break, % |
| WPU-AOP-S2 | 43.2 | +16 | 10.6 | 239 |
| WPU-AOP-S2-2 | 43.2 | +13 | 9.7 | 229 |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for producing a polyurethane dispersion, the method comprising:
a) epoxidizing and ring opening an algal triglyceride oil, thereby generating an epoxidized and ring opened algal oil polyol;
b) reacting the epoxidized and ring opened algal oil polyol with an isocyanate and an ionogenic molecule, thereby generating an isocyanate-terminated pre-polymer;
c) neutralizing the isocyanate-terminated pre-polymer with an acid or a base, thereby generating a neutralized isocyanate-terminated pre-polymer; and
d) dispersing the neutralized isocyanate-terminated pre-polymer in water, thereby generating the polyurethane dispersion,
wherein the algal triglyceride oil comprises at least 60% of one or more monounsaturated fatty acids.

2. The method of claim 1, wherein the one or more monounsaturated fatty acids is a C18:1 fatty acid.

3. The method of claim 1, wherein the one or more monounsaturated fatty acids is oleic acid.

4-5. (canceled)

6. The method of claim 1, wherein the algal triglyceride oil comprises at least 60% of oleic acid.

7. The method of claim 1, wherein the algal triglyceride oil comprises at least 80% of oleic acid.

8. The method of claim 1, wherein the algal triglyceride oil comprises at least 90% of oleic acid.

9. The method of claim 1, wherein the algal triglyceride oil has an iodine value of at least 80 g I₂/100 g.

10-11. (canceled)

12. The method of claim 1, wherein the ionogenic molecule is dimethylolpropionic acid (DMPA).

13. The method of claim 1, wherein the ionogenic molecule is N-methyldiethanolamine (MDEA).

14. (canceled)

15. The method of claim 1, wherein the neutralizing of the isocyanate-terminated pre-polymer is with acetic acid.

16. The method of claim 1, wherein the neutralizing of the isocyanate-terminated pre-polymer is with triethylamine (TEA).

17. The method of claim 1, further comprising reacting the neutralized isocyanate-terminated pre-polymer with a chain extender prior to dispersing.

18. The method of claim 17, wherein the chain extender is ethylene diamine (EDA).

19-20. (canceled)

21. The method of claim 1, further comprising solubilizing the isocyanate-terminated pre-polymer in methyl ethyl ketone prior to neutralizing.

22-23. (canceled)

24. The method of claim 1, wherein the polyurethane dispersion is a cationic polyurethane dispersion.

25. The method of claim 1, wherein the polyurethane dispersion is an anionic polyurethane dispersion.

26. The method of claim 1, wherein the polyurethane dispersion has a bio-based content of at least 50% as assessed by ASTM 6866.

27-29. (canceled)

30. The method of claim 1, wherein the polyurethane dispersion has a maximum particle size of less than about 100 nm as determined by dynamic light scattering.

31. The method of claim 1, wherein the polyurethane dispersion has a polydispersity index of less than about 0.15 as determined by dynamic light scattering.

32. The method of claim 1, wherein the polyurethane dispersion has a viscosity of less than about 10 mPa·s at ambient temperature.

33. (canceled)

34. The method of claim 1, further comprising preparing a film with the polyurethane dispersion, wherein the film is water repellent.

35. The method of claim 1, further comprising preparing a film with the polyurethane dispersion, wherein the film is oil repellent.

36. The method of claim 1, further comprising preparing a film with the polyurethane dispersion, wherein the film is stain resistant.

37. (canceled)

38. The method of claim 1, further comprising preparing a film with the polyurethane dispersion, wherein the film has a water contact angle of greater than 90 degrees.

39. The method of claim 1, further comprising preparing a film with the polyurethane dispersion, wherein the film has a water absorption of less than 10% as determined gravimetrically.

40. The method of claim 1, further comprising preparing a film with the polyurethane dispersion, wherein the film has a water absorption of less than 5% as determined gravimetrically.

41. The method of claim 1, further comprising preparing a film with the polyurethane dispersion, wherein the film has a tensile strength of about 10 MPa to about 20 MPa.

42. The method of claim 1, further comprising preparing a film with the polyurethane dispersion, wherein the film has an elongation at break of about 200% to about 300%.

43-211. (canceled)
